(19) United States
(12) Patent Application Publication
(10) Pub. No.: US 2026/0279805 A1
(43) Pub. Date: Sep. 17, 2026

(54) A COMPOSITE COMPRISING CARBON NANOTUBES AND USES THEREOF AS A CATHODE

(71) Applicant: YEDA RESEARCH AND DEVELOPMENT CO. LTD., Rehovot (IL)

(72) Inventors: Boris RYBTCHINSKI, Givaataim (IL); Lior SNARSKI, Rehovot (IL); Nadav YAHALOM, Rehovot (IL); Haim WEISSMAN, Rehovot (IL)

(73) Assignee: YEDA RESEARCH AND DEVELOPMENT CO. LTD., Rehovot (IL)

(21) Appl. No.: 19/168,844

(22) PCT Filed: Mar. 27, 2024
(86) PCT No.: PCT/IL2024/050319

§ 371 Date: Sep. 25, 2025

(30) Foreign Application Priority Data
Mar. 27, 2023 (IL) 301716

(51) Int. Cl. H01M 4/587; C01B 32/158; C01B 32/159; C01B 32/168; H01M 4/36; H01M 10/0525

(52) U.S. Cl. CPC H01M 4/587; C01B 32/158; C01B 32/159; C01B 32/168; H01M 4/366; C01B 2202/02; C01B 2202/06; C01B 2202/22; H01M 10/0525

(57) ABSTRACT

Provided herein a composite comprising a multi-layered structure comprising at least one layer of multi-walled carbon nanotube (MWCNT) and at least one layer of single-walled carbon nanotube (SWCNT); and its use as a cathode for e.g. LSBs (lithium sulfur batteries).

### FIELD OF THE INVENTION

Provided herein a composite comprising a multi-layered structure comprising at least one layer of multi-walled carbon nanotube (MWCNT) and at least one layer of single-walled carbon nanotube (SWCNT); and its use as a cathode for e.g. LSBs (lithium sulfur batteries).

### BACKGROUND OF THE INVENTION

The search for efficient energy storage systems with high energy density, high stability, low cost, and low environmental impact is of key importance to address current energy and environmental challenges. Currently, rechargeable Lithium-Ion batteries (LIB) represent a common energy storage system (Manthiram, A. A Reflection on Lithium-Ion Battery Cathode Chemistry. Nature Communications 2020, 11 (1). https://doi.org/10.1038/s41467-020-15355-0). However, they reached their theoretical energy density limit, and the metals used in the cathode (LiMO₂, M=Co, Mn, Ni) are either costly or hazardous (Mohamed, N.; Allam, N. K. Recent Advances in the Design of Cathode Materials for Li-Ion Batteries. RSC Advances 2020, 10 (37), 21662-21685. https://doi.org/10.1039/d0ra03314f). Since their discovery in the 1960s (Brummer, S. B.; Rauh, R. D.; Marston, J. M.; Shuker, F. S. Low temperature lithium/sulfur secondary battery. Annual progress report, Dec. 1, 1974-Dec. 1, 1975. [Ambient-temperature battery with dissolved S] https://www.osti.gov/biblio/7123189), lithium-sulfur batteries (LSB's) have been considered promising candidates to meet the increasing energy demands and address cost and environmental concerns. The sulfur cathode possesses theoretical capacity of 1675 mAh/g and theoretical energy density of 2600 Wh/kg (Yang, Y.; Zheng, G.; Cui, Y. Nanostructured Sulfur Cathodes. Chemical Society Reviews 2013, 42 (7), 3018. https://doi.org/10.1039/c2cs35256g; and Chen, T.; Zhang, Z.; Cheng, B.; Chen, R.; Hu, Y.; Ma, L.; Zhu, G.; Liu, J.; Jin, Z. Self-Templated Formation of Interlaced Carbon Nanotubes Threaded Hollow Co₃S₄ Nanoboxes for High-Rate and Heat-Resistant Lithium-Sulfur Batteries. Journal of the American Chemical Society 2017, 139 (36), 12710-12715. https://doi.org/10.1021/jacs.7b06973), much higher than conventional cathode materials currently used in LIB batteries. Moreover, sulfur is inexpensive, abundant, and nontoxic. However, several challenges hinder the practical use of LSB's (Yin, Y.-X.; Xin, S.; Guo, Y.-G.; Wan, L.-J. Lithium-Sulfur Batteries: Electrochemistry, Materials, and Prospects. Angewandte Chemie International Edition 2013, 52 (50), 13186-13200. https://doi.org/10.1002/anie.201304762). First, poor electrical conductivity of sulfur (5×10⁻³⁰ S/cm) and the final discharge product, LiS₂, limits active material utilization, in particular due to a passivation layer over the cathode surface. Second, the dissolution of intermediate long-chain Lithium Polysulfide (LiPS) species (Li₂Sₓ, 4<X<8) into the electrolyte leads to loss of active material (shuttle effect (Evers, S.; Nazar, L. F. New Approaches for High Energy Density Lithium-Sulfur Battery Cathodes. Accounts of Chemical Research 2012, 46 (5), 1135-1143. https://doi.org/10.1021/ar3001348)). Finally, the large volumetric expansion (~80%) of sulfur upon lithiation, causes structural damage to the cathode. Today there is apparent consensus that the encapsulation of sulfur in porous carbon hosts not only enhances pathways for sulfur reduction/oxidation process, but also helps trapping the soluble LiPS inside the porous structure, leading to better suppression of the shuttle effect (Ogoke, O.; Wu, G.; Wang, X.; Casimir, A.; Ma, L.; Wu, T.; Lu, J. Effective Strategies for Stabilizing Sulfur for Advanced Lithium-Sulfur Batteries. Journal of Materials Chemistry A 2017, 5 (2), 448-469. https://doi.org/10.1039/c6ta07864h). Over the years, many sulfur-carbon systems have been investigated as cathodes, including graphene (Xi, K.; Kidambi, P. R.; Chen, R.; Gao, C.; Peng, X.; Ducati, C.; Hofmann, S.; Kumar, R. V. Binder Free Three-Dimensional Sulphur/Few-Layer Graphene Foam Cathode with Enhanced High-Rate Capability for Rechargeable Lithium Sulphur Batteries. Nanoscale 2014, 6 (11), 5746-5753. https://doi.org/10.1039/c4nr00326h), graphene oxide (Hu, G.; Xu, C.; Sun, Z.; Wang, S.; Cheng, H.-M.; Li, F.; Ren, W. 3D Graphene-Foam-Reduced-Graphene-Oxide Hybrid Nested Hierarchical Networks for High-Performance Li—S Batteries. Advanced Materials 2015, 28 (8), 1603-1609. https://doi.org/10.1002/adma.201504765), carbon nanofiber (CNF) (Ji, L.; Rao, M.; Aloni, S.; Wang, L.; Cairns, E. J.; Zhang, Y. Porous Carbon Nanofiber-Sulfur Composite Electrodes for Lithium/Sulfur Cells. Energy & Environmental Science 2011, 4 (12), 5053. https://doi.org/10.1039/clee02256c), porous carbon (Xi, K.; Cao, S.; Peng, X.; Ducati, C.; Vasant Kumar, R.; Cheetham, A. K. Carbon with Hierarchical Pores from Carbonized Metal-Organic Frameworks for Lithium Sulphur Batteries. Chemical Communications 2013, 49 (22), 2192. https://doi.org/10.1039/c3cc38009b), amorphous carbon (OKABE, S.; UCHIDA, S.; MATSUI, Y.; YAMAGATA, M.; ISHIKAWA, M. Performance Enhancement of Rechargeable Sulfur Cathode Utilizing Microporous Activated Carbon Composite. Electrochemistry 2017, 85 (10), 671-674. https://doi.org/10.5796/electrochemistry.85.671) and activated carbon fibres (ACF) (Elazari, R.; Salitra, G.; Garsuch, A.; Panchenko, A.; Aurbach, D. Sulfur-Impregnated Activated Carbon Fiber Cloth as a Binder-Free Cathode for Rechargeable Li—S Batteries. Advanced Materials 2011, 23 (47), 5641-5644. https://doi.org/10.1002/adma.201103274). Carbon Nanotubes (CNT), a one-dimensional (1D) carbon material composed of rolled-up graphene sheets, has been widely investigated as the conductive material in LSB cathodes (Zheng, G.; Yang, Y.; Cha, J. J.; Hong, S. S.; Cui, Y. Hollow Carbon Nanofiber-Encapsulated Sulfur Cathodes for High Specific Capacity Rechargeable Lithium Batteries. Nano Letters 2011, 11 (10), 4462-4467. https://doi.org/10.1021/nl2027684; Zhou, G.; Wang, D.-W.; Li, F.; Hou, P.-X.; Yin, L.; Liu, C.; Lu, G. Q. (Max); Gentle, I. R.; Cheng, H.-M. A Flexible Nanostructured Sulphur-Carbon Nanotube Cathode with High Rate Performance for Li—S Batteries. Energy & Environmental Science 2012, 5 (10), 8901. https://doi.org/10.1039/c2ee22294a; Zhao, M.-Q.; Liu, X.-F.; Zhang, Q.; Tian, G.-L.; Huang, J.-Q.; Zhu, W.; Wei, F. Graphene/Single-Walled Carbon Nanotube Hybrids: One-Step Catalytic Growth and Applications for High-Rate Li—S Batteries. ACS Nano 2012, 6 (12), 10759-10769. https://doi.org/10.1021/nn304037d; Cheng, X.-B.; Huang, J.-Q.; Zhang, Q.; Peng, H.-J.; Zhao, M.-Q.; Wei, F. Aligned Carbon Nanotube/Sulfur Composite Cathodes with High Sulfur Content for Lithium-Sulfur Batteries. Nano Energy 2014, 4, 65-72. https://doi.org/10.1016/j.nanoen.2013.12.013.; and Yuan, Z.; Peng, H.-J.; Huang, J.-Q.; Liu, X.-Y.; Wang, D.-W.; Cheng, X.-B.; Zhang, Q. Hierarchical Free-Standing Carbon-Nanotube Paper Electrodes with Ultrahigh Sulfur-Loading for Lithium-Sulfur Batteries. Advanced Functional Materials 2014, 24 (39), 6105-6112. https://doi.org/10.1002/adfm.201401501). Besides their high conductivity, CNTs possess high mechanical strength, which can be crucial to address the volume expansion issue. In addition, high specific surface area (SSA) of CNT materials is beneficial for the sulfur mass loading. Many strategies have been investigated for embedding sulfur within the carbon hosts, including vapor infiltration (Li, M.; Carter, R.; Douglas, A.; Oakes, L.; Pint, C. L. Sulfur Vapor-Infiltrated 3D Carbon Nanotube Foam for Binder-Free High Areal Capacity Lithium-Sulfur Battery Composite Cathodes. ACS Nano 2017, 11 (5), 4877-4884. https://doi.org/10.1021/acsnano.7b01437), solvent evaporation (Dörfler, S.; Hagen, M.; Althues, H.; Tübke, J.; Kaskel, S.; Hoffmann, M. J. High Capacity Vertical Aligned Carbon Nanotube/Sulfur Composite Cathodes for Lithium-Sulfur Batteries. Chemical Communications 2012, 48 (34), 4097. https://doi.org/10.1039/c2cc17925c), chemical deposition (Ji, L.; Rao, M.; Zheng, H.; Zhang, L.; Li, Y.; Duan, W.; Guo, J.; Cairns, E. J.; Zhang, Y. Graphene Oxide as a Sulfur Immobilizer in High Performance Lithium/Sulfur Cells. Journal of the American Chemical Society 2011, 133 (46), 18522-18525. https://doi.org/10.1021/ja206955k) and melt diffusion (Gueon, D.; Hwang, J. T.; Yang, S. B.; Cho, E.; Sohn, K.; Yang, D.-K.; Moon, J. H. Spherical Macroporous Carbon Nanotube Particles with Ultrahigh Sulfur Loading for Lithium-Sulfur Battery Cathodes. ACS Nano 2018, 12 (1), 226-233. https://doi.org/10.1021/acsnano.7605869). It has been shown that for LSB to have the volumetric energy density similar or higher that of LIB, sulfur loading must be high (around 70% by weight, or higher) (Yang, Y.; Zheng, G.; Cui, Y. Nanostructured Sulfur Cathodes. Chemical Society Reviews 2013, 42 (7), 3018. https://doi.org/10.1039/c2cs35256g). Furthermore, in order to increase the CNT/S contact area necessary for an effective reduction/oxidation process, sulfur must efficiently infiltrate and interact with the conductive carbon network.

The influence of carbon host pore diameters on the LSB performance has been investigated (Wang, M.; Xia, X.; Zhong, Y.; Wu, J.; Xu, R.; Yao, Z.; Wang, D.; Tang, W.; Wang, X.; Tu, J. Porous Carbon Hosts for Lithium-Sulfur Batteries. Chemistry—A European Journal 2018, 25 (15), 3710-3725. https://doi.org/10.1002/chem.201803153). Although macropores (>50 nm) and open-pore structure offer fast ionic diffusion, good electrolyte penetration and buffering volume expansion, they lack the ability to adsorb LiPS, leading to severe shuttle effect and capacity fade. On the other hand, micropores (<2 nm) trap LiPS and have higher surface area crucial for sufficient sulfur loading but their pore dimensions hinder diffusion rates and electrolyte accessibility within the pores.

This invention provides a multi-walled carbon nanotube (MWCNT)-single-walled carbon nanotube (SWCNT) composites and their use as cathodes in LSBs (lithium sulfur batteries).

### SUMMARY OF THE INVENTION

In one embodiment, this invention is directed to a composite comprising a multi-layered structure comprising at least one layer of multi-walled carbon nanotube (MWCNT) and at least one layer of single-walled carbon nanotube (SWCNT), wherein the weight ratio of the MWCNT to SWCNT is 10:1 to 1:10, respectively.

In one embodiment, this invention is directed to a composite comprising a multi-layered structure comprising at least one layer of multi-walled carbon nanotube (MWCNT) and at least one layer of single-walled carbon nanotube (SWCNT), wherein the weight ratio of the MWCNT to SWCNT is 10:1 to 1:10, respectively; and each layer optionally further consists an aromatic compound. In another embodiment, the composite further comprises sulfur.

In one other embodiment, this invention is directed to a method of preparing a composite, comprising a multi-layered structure comprising at least one layer of multi-walled carbon nanotube (MWCNT) and at least one layer of single-walled carbon nanotube (SWCNT), wherein the weight ratio of the MWCNT to SWCNT is 10:1 to 1:10, respectively; and each layer optionally further consists of an aromatic compound, wherein the method comprises:
mixing multi-walled carbon nanotube (MWCNT), a first solvent and optionally an aromatic compound;
mixing a grinded single-walled carbon nanotube (SWCNT), a second solvent and optionally an aromatic compound;
sonicating separately both mixtures;
filtering the sonicated SWCNT mixture over a membrane and then filtering the sonicated MWCNT mixture over the membrane with the filtered SWCNT, providing a film having the MWCNT layer on top of the SWCNT layer;
washing the provided film with the first solvent to remove excess optional aromatic compound;
laminating the provided film, providing a layered film and then peeling the layered film off the membrane; and
cooling the layered film to room temperature to obtain the composite.

In one other embodiment, this invention is directed to method of preparing a sulfur containing composite comprising sulfur and a multi-layered structure comprising at least one layer of multi-walled carbon nanotube (MWCNT) and at least one layer of single-walled carbon nanotube (SWCNT), wherein the weight ratio of the MWCNT to SWCNT is 10:1 to 1:10, respectively; and each layer optionally further consists an aromatic compound, wherein the method comprises:
mixing multi-walled carbon nanotube (MWCNT), a first solvent and optionally an aromatic compound;
mixing a grinded single-walled carbon nanotube (SWCNT), a second solvent and optionally an aromatic compound;
sonicating separately both mixtures;
filtering the sonicated SWCNT mixture over a membrane and then filtering the sonicated MWCNT mixture over the membrane with the filtered SWCNT, providing a film having the MWCNT layer on top of the SWCNT layer;
washing the provided film with the first solvent to remove excess optional aromatic compound;
laminating the provided film, providing a layered film and then peeling the layered film off the membrane;
adding sulfur to the top of the layered film while heating to 120-180° C.; and
cooling the sulfur treated film to room temperature to obtain the composite.

In one additional embodiment, this invention is directed to a cathode comprising the composite of this invention.

In one additional embodiment, this invention is directed to a method of preparing a cathode, comprising:
cutting the composite of this invention; and
drying the cut composite to provide the cathode.

In one additional embodiment, this invention is directed to a battery comprising a cathode of this invention.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIGS. 1A-1C depict various configurations of MWCNT-SWCNT composites. FIG. 1A: blocks; FIG. 1B: alternating; and FIG. 1C: random configurations.

FIG. 2 depicts a method of preparing a non-sulfur-composite.

FIG. 3 Schematic illustration of the CNT and Sulfur-composite fabrication process.

FIG. 4 depicts an exemplary battery setup (a “coin cell”).

FIG. 5 depicts a TGA of a sulfur containing composite. FIG. 6A-6I depict morphology and elemental mapping of a sulfur containing composite. FIG. 6A: Cross section elemental analysis of the composite; FIG. 6B: the corresponding C (carbon) mapping; FIG. 6C: the corresponding S (sulfur) mapping; FIG. 6D: SEM image of cathode layers and corresponding high-magnification images of MWCNT layer (FIGS. 6E-6F), interlayer (FIGS. 6G-6H) and SWCNT layer (FIGS. 6I-6J). SWCNTs and MWCNTs can be distinguished by the order of deposition, denser SWCNT layer, (FIGS. 6G and 6I) typical bundling of SWCNTs, and (FIGS. 6F and 6H) better exfoliation of MWCNTs.

FIG. 7 depict SEM images of a sulfur containing composite, showing the bundled nature of MWCNT (left column) and SWCNT (right column) at different magnifications.

FIGS. 8A-8D depict sulfur-containing composite surface analysis. FIG. 8A: morphology of the sulfur-containing composite; FIG. 8B: C (carbon) mapping; FIG. 8C: EDS mapping; and FIG. 8D: S (sulfur) mapping.

FIGS. 9A-9B depict N₂ adsorption/desorption studies of non-sulfur composite (compCNT). FIG. 9A: N₂ adsorption isotherm; and FIG. 9B: (b) adsorption pore size distribution (BJH approach). SW-BP: single walled carbon nanotube buckypaper. MW-BP: multi walled carbon nanotube buckypaper.

FIGS. 10A-10B depict mechanical properties of non-sulfur composite (compCNT). FIG. 10A: Stress-strain curve; and FIG. 10B: i) photographs of SW-BP (folding and unfolding, inset: folded SW-BP), ii) photographs of MW-BP folding and the resulting breaking. SW-BP: single walled carbon nanotube buckypaper. MW-BP: multi walled carbon nanotube buckypaper.

FIGS. 11A-11B depict electrochemical impedance spectroscopy (EIS) studies of the sulfur containing composite (compCNT/S). FIG. 11A: Nyquist plots of the cells; and FIG. 11B: equivalent circuit where R1 indicates the ohmic contributions of the cell (electrolyte, separator, electrical connections), R2 denotes the charge transfer resistance of electrolyte-electrode interfaces, Q2 represents the constant phase elements, and W2 is the warburg ion diffusion impedance. SW-BP-C: single walled carbon nanotube buckypaper cathode. MW-BP-C: multi walled carbon nanotube buckypaper cathode.

FIGS. 12A-12D depict cycling studies of batteries comprising compCNT/S (sulfur-containing composite). FIG. 12A: cycling performances of SW-BP-C, MW-BP-C and compCNT/S cells at constant rate of 0.1C; FIG. 12B: their corresponding coulombic efficiency (CE); FIG. 12C: Cycling performances and CE of selected compCNT/S cell at constant rate of 0.1C; and FIG. 12D: Rate performance of compCNT/S cell at various C rates.

FIGS. 13A-13F Cross section elemental mapping analysis of compCNT/S (sulfur containing composite) before (FIGS. 13A-13C) and after (FIGS. 13D-13F) battery cycling. FIG. 13A: compCNT/S morphology before cycling; and FIG. 13B: corresponding S; and FIG. 13C: corresponding C+S mapping; FIG. 13D: compCNT/S morphology after cycling; and FIG. 13E: corresponding S; and FIG. 13F: corresponding C+S mapping.

FIG. 14A-14C SEM images and XPS analysis of the compCNT/S (sulfur containing composite) after 50 cycles at 0.1C. FIG. 14A: XPS S2p spectra of cells at charge, discharge, and blank states; FIG. 14B: SEM image of the corresponding charge cell surface. Inset is high-magnification image of same cell; and FIG. 14C: SEM images of the corresponding discharge cell surface. Inset is high-magnification image of same cell.

FIGS. 15A-15B Charge state oxidized sulfur species within compCNT/S (sulfur-containing composite) cell. FIG. 15A: surface morphology; and FIG. 15B: line-cross scan of the species.

FIGS. 16A-16C SEM images and XPS analysis of the compCNT/S (sulfur-containing composite) cell after 50 cycles at 0.1C. FIG. 16A: XPS S2p spectra of cells at charge, discharge, and blank states; FIG. 16B: SEM image of the corresponding charge cell surface. Inset is high-magnification image of same cell; and FIG. 16C: SEM images of the corresponding discharge cell surface. Inset is high-magnification image of same cell.

FIG. 17 depicts a comparison to the published LSB (lithium sulfur batteries) cathodes based on CNT.

### DETAILED DESCRIPTION OF THE PRESENT INVENTION

In the following detailed description, numerous specific details are set forth in order to provide a thorough understanding of the invention. However, it will be understood by those skilled in the art that this invention may be practiced without these specific details. In other instances, well-known methods, procedures, and components have not been described in detail so as not to obscure this invention.

Lithium-sulfur (Li—S) batteries (LSBs) have high energy densities and employ inexpensive materials. However, the poor sulfur conductivity and rapid capacity fading hamper their applications. provided herein a composite cathode based on multi-walled carbon nanotubes (MWCNTs) and single walled carbon nanotubes (SWCNTs), whose fabrication follows a solution-based, scalable method. The two CNT types create a synergic effect: SWCNTs result in high conductivity, high surface area, and mechanical strength/flexibility; and MWCNTs' larger pores ensure facile ionic diffusion and trapping of lithium polysulfides.

### MWCNT-SWCNT Composites

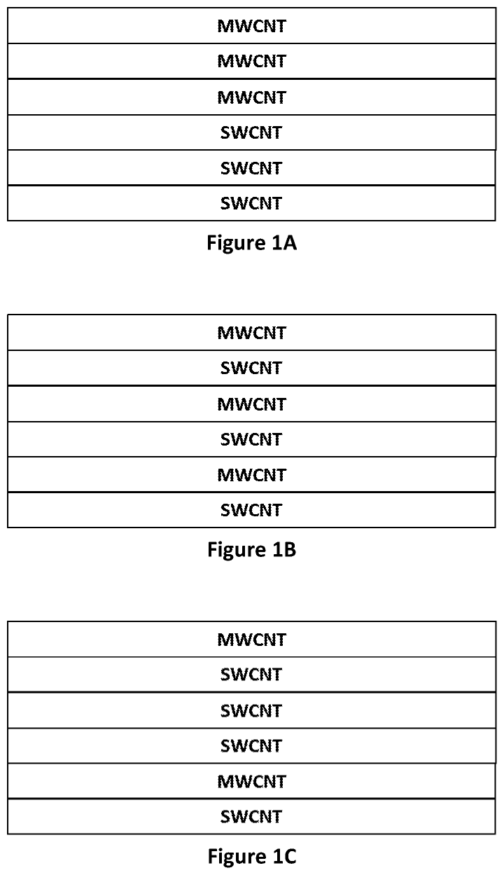

In some embodiments, this invention provides a composite comprising a multi-layered structure comprising at least one layer of multi-walled carbon nanotube (MWCNT) and at least one layer of single-walled carbon nanotube (SWCNT). In In some embodiment, this invention provides a composite comprising a multi-layered structure comprising at least one layer of multi-walled carbon nanotube (MWCNT) and at least one layer of single-walled carbon nanotube (SWCNT), wherein the weight ratio of the MWCNT to SWCNT is 10:1 to 1:10, respectively. In one other embodiment, the composite comprises a multiplicity of layers of multi-walled carbon nanotube (MWCNT) and a multiplicity of layers of single-walled carbon nanotube (SWCNT), wherein the weight ratio of the MWCNT to SWCNT is 10:1 to 1:10, respectively, and wherein the layers are organized in any plausible way, for example—blocks (FIG. 1A), alternating (FIG. 1B) and random (FIG. 1C) configurations. In other embodiments, the composite comprises one layer of multi-walled carbon nanotube (MWCNT) and one layer of single-walled carbon nanotube (SWCNT), wherein the weight ratio of the MWCNT to SWCNT is 10:1 to 1:10, respectively. In another embodiment, the MWCNT is on top of the SWCNT. In another embodiment, the SWCNT is the first layer.

In one embodiment, the composite further comprises sulfur, i.e. the composite is a “sulfur-containing composite”. In one other embodiment, this invention provides composite comprising sulfur, at least one layer of multi-walled carbon nanotube (MWCNT) and at least one layer of single-walled carbon nanotube (SWCNT).

In some embodiments, the composite of this invention further comprises an aromatic compound.

In one embodiment, the composite does not comprise sulfur, i.e. the composite is a “non-sulfur-composite”. In one embodiment, the (non-sulfur) composite consists essentially of at least one layer of multi-walled carbon nanotube and at least one layer of single-walled carbon nanotube. In one other embodiment, the (non-sulfur) composite consists essentially of a at least one layer of multi-walled carbon nanotube and at least one layer of single-walled carbon nanotube wherein each layer of the single-walled carbon nanotube and the multi-walled carbon nanotube further consist of an aromatic compound. In another embodiment, the (non-sulfur) composite consists essentially of a at least one layer of multi-walled carbon nanotube and at least one layer of single-walled carbon nanotube wherein each layer of the single-walled carbon nanotube further of an aromatic compound. In another embodiment, the (non-sulfur) composite consists essentially of a at least one layer of multi-walled carbon nanotube and at least one layer of single-walled carbon nanotube wherein each layer of the multi-walled carbon nanotube further consists of an aromatic compound.

In one embodiment, the composite comprising sulfur and a multi-layered structure comprising at least one layer of multi-walled carbon nanotube (MWCNT) and at least one layer of single-walled carbon nanotube (SWCNT), wherein the weight ratio of the MWCNT to SWCNT is 10:1 to 1:10, respectively.

In one embodiment, the composite comprising sulfur and a multi-layered structure comprising at least one layer of multi-walled carbon nanotube (MWCNT) and at least one layer of single-walled carbon nanotube (SWCNT), wherein the weight ratio of the MWCNT to SWCNT is 10:1 to 1:10, respectively and the layers further consists of an aromatic compound.

In some embodiments, the aromatic compound within the composites of this invention is at least one of perylene diimide, naphthalene diimide, phthalocyanine, anthraquinone, acridine, naphthalene disulfonic acid, caffeic acid, phenazine, indigo, rhodamine, phenothiazine, thymolphthalein, aramid, derivative thereof, salt thereof or any combination thereof. In one embodiment, the perylene diimide derivative is ethyl propyl perylene diimide. In one other embodiment, the anthraquinone derivative is a dihydroxy or trihydroxy anthraquinone. In another embodiment, anthraquinone derivative is purpurin or alizarin. In one other embodiment, the acridine derivative is acridine orange. In one other embodiment, the phenazine derivative is safranin.

In some embodiments (including all composites described herein, e.g. composites with or without sulfur and with or without an aromatic compound), the weight ratio of the MWCNT to SWCNT is 10:1 to 1:10, respectively. In one embodiment, the weight ratio of the MWCNT to SWCNT within the composites of this invention is 1:1, respectively. In another embodiment the the weight ratio of the MWCNT to SWCNT within the composites of this invention is 1:1, 1:2, 1:3, 1:5, 1:7, 10:1, 9:1, 8:1, 6:1, 5:1, 3:1 or 2:1 respectively.

In some embodiments, the sulfur within the composites of this invention weighs 55-75% of the composition total weight. In another embodiment, the sulfur weighs between 55%-60% of the composition total weight. In another embodiment, the sulfur weighs between 55%-70% of the composition total weight. In another embodiments, the sulfur weighs between 60%-75% of the composition total weight. In one embodiment, the sulfur weighs ~65% of the composition total weight. Each possibility represents a separate embodiment of this invention.

In some embodiments, the composite of this invention is a membrane, dispersion, buckypaper, bulk material, coating, film, paste, paint, gel, powder or aerogel. In one embodiment the composite is a buckypaper. In another embodiment, the composite is a free-standing buckypaper. Each possibility represents a separate embodiment of this invention.

In some embodiments, the SWCNT within the composites of this invention is a grinded SWCNT.

In some embodiments, the MWCNT layer within the composites of this invention is found above the SWCNT layer.

In some embodiments, non-sulfur composites (e.g. comprising a layer of multi-walled carbon nanotube (MWCNT) and a layer of single-walled carbon nanotube (SWCNT), wherein the weight ratio of the MWCNT to SWCNT is 10:1 to 1:10, respectively; and optionally an aromatic×compound) have the properties as described hereinbelow.

In some embodiments, the non-sulfur composites have a Young's modulus of 60-150 Mpa. In some other embodiments, the Young's modulus is 105±30 Mpa.

In some embodiments, the non-sulfur composites have an electrical conductivity of 2-4×10⁵ S/m. In some other embodiments, the electrical conductivity is 2.8×10⁵±4.8×10⁴ S/m.

In some embodiments, the non-sulfur composites have a surface area of 250-300 m²/g. In some other embodiments, the surface area is 270.2±4 m²/g.

In some embodiments, the non-sulfur composites have a pore volume of 0.6-1 cm³/g. In some other embodiments, the pore volume is 0.83±0.01 cm³/g.

The non-sulfur composites of this invention have good conductivity, porosity, mechanical strength, electrochemical properties, and flexibility.

In some embodiments, the length of the SWCNT is 3-50 μm. In one embodiment, the length of the SWCNT is 5-10 μm. In another embodiment, of the SWCNT is 10-20 μm. In another embodiment, of the SWCNT is 30-50 μm. In another embodiment, of the SWCNT is 5-50 μm.

In one embodiment, this invention provides a method of preparing a composite comprising a multi-layered structure comprising at least one layer of multi-walled carbon nanotube (MWCNT) and at least one layer of single-walled carbon nanotube (SWCNT), wherein the weight ratio of the MWCNT to SWCNT is 10:1 to 1:10, respectively; and each layer optionally further consists an aromatic compound, wherein the method comprises:
mixing multi-walled carbon nanotube (MWCNT), a first solvent and optionally an aromatic compound;
mixing a grinded single-walled carbon nanotube (SWCNT), a second solvent and optionally an aromatic compound;
sonicating separately both mixtures;
filtering the sonicated SWCNT mixture over a membrane and then filtering the sonicated MWCNT mixture over the membrane with the filtered SWCNT, providing a film having the MWCNT layer on top of the SWCNT layer;
washing the provided film with the first solvent to remove excess optional aromatic compound;
laminating the provided film, providing a layered film and then peeling the layered film off the membrane; and
cooling the layered film to room temperature to obtain the composite.

In one embodiment, this invention provides a method of preparing a sulfur containing composite comprising, sulfur and a multi-layered structure comprising at least one layer of multi-walled carbon nanotube (MWCNT) and at least one layer of single-walled carbon nanotube (SWCNT), wherein the weight ratio of the MWCNT to SWCNT is 10:1 to 1:10, respectively; each layer optionally further consists an aromatic compound; wherein the method comprises, comprising:
mixing multi-walled carbon nanotube (MWCNT), a first solvent and optionally an aromatic compound;
mixing a grinded single-walled carbon nanotube (SWCNT), a second solvent and optionally an aromatic compound;
sonicating separately both mixtures;
filtering the sonicated SWCNT mixture over a membrane and then filtering the sonicated MWCNT mixture over the membrane with the filtered SWCNT, providing a film having the MWCNT layer on top of the SWCNT layer;
washing the provided film with the first solvent to remove excess optional aromatic compound;
laminating the provided film, providing a layered film and then peeling the layered film off the membrane;
adding sulfur to the top of the layered film while heating to 120-180° C.; and
cooling the sulfur treated film to room temperature to obtain the composite.

In another embodiment, the aromatic compound is perylene diimide, naphthalene diimide, phthalocyanine, anthraquinone, acridine, naphthalene disulfonic acid, caffeic acid, phenazine, indigo, rhodamine, phenothiazine, thymolphthalein, aramid, derivative thereof, salt thereof or any combination thereof.

In one embodiment, the first and second solvents are each independently selected from the group consisting of: chloroform, methylene chloride, carbon tetrachloride dichloroethane, glyme, diglyme, triglyme, triethylene glycol, trichloroethane, tertbutyl methyl ether, tetrachloro ethane, acetone, THF, DMSO, toluene, benzene, alcohol, isopropyl alcohol (IPA), chlorobenzene, acetonitrile, dioxane, ether, NMP, DME, DMF, ethyl-acetate and any combination thereof. In another embodiment, the first solvent is chloroform. In another embodiment, the second solvent is IPA

In one embodiment, the membrane is polyethersulphone (PES), Polyvinylidene fluoride (PVDF) or Teflon membrane.

In one embodiment, the sulfur addition heating temperature is 120-180° C. In another embodiment, the temperature is 130-170° C. In another embodiment, the temperature is 140-160° C. In another embodiment, the temperature is 140-180° C. In another embodiment, the temperature is 120-160° C. In another embodiment, the temperature is 155° C. In one embodiment, the heating is done for 10-480 minutes. In another embodiment, the heating is done for 20-240 minutes. the heating is done for 40-200 minutes, the heating is done for 60-180 minutes, the heating is done for 10-150 minutes, the heating is done for 120 minutes.

In some embodiments, “room temperature” is defined as 10-40° C. In one embodiment, “room temperature” is 15-30° C. In one other embodiment, “room temperature” is 20-30° C. In another embodiment, “room temperature” is 25° C.

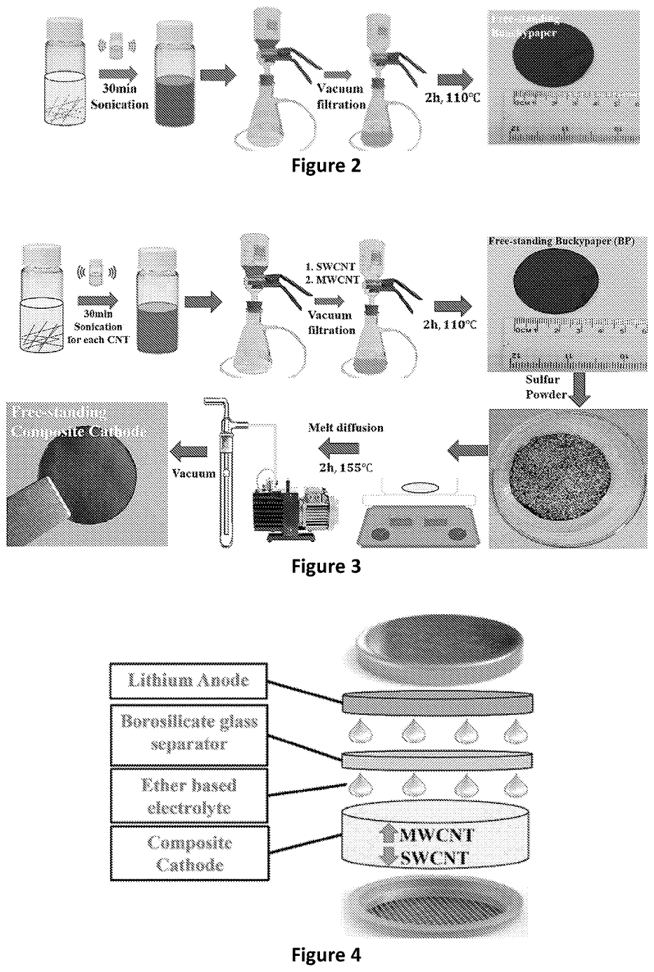

In one embodiment, an exemplary method for preparing a non-sulfur composite is illustrated in FIG. 2.

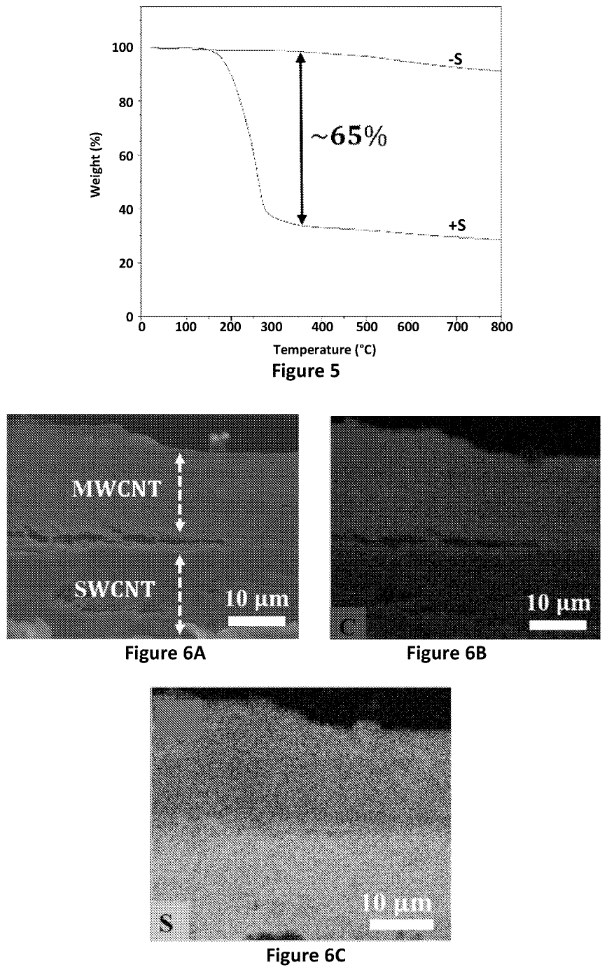

In one embodiment, an exemplary method for preparing a sulfur-containing composite sulfur is illustrated in FIG. 3.

### Cathodes Comprising MWCNT-SWCNT Composites

In some embodiments, this invention provides a cathode comprising the composite of this invention, as described hereinabove. In one embodiment, this invention provides a method of preparing a cathode, comprising
cutting the sulfur-containing-composite of this invention; and
drying the cut composite to provide the cathode.

In one embodiment, the composite is cut to discs.

In one embodiment, the composite is cut via a steel circle cutter, scalpel or scissors.

In one embodiment, the cut composite is dried by vacuum.

### Batteries Comprising MWCNT-SWCNT Composites

In some embodiments, this invention provides a battery comprising the cathode of this invention as described hereinabove, a lithium metal anode and an electrolyte. In one embodiment, the battery further comprises a separator.

In some embodiments, the lithium metal anode is Li-metal foil or any other Li metal form as known in the art.

In some embodiments, the electrolyte is ether based. In another embodiment, the electrolyte is a combination of DME (1,2-dimethoxyethane), DOL (1-3 Dioxolane), LiTFSI (lithium bis(trifluoromethanesulfonyl)imide) and LiNO₃. In another embodiment, the electrolyte was made by mixing DME:DOL 1:1 volume ratio, 1M LiTFSI and 1 wt % LiNO₃. Each possibility represents a separate embodiment of this invention.

In some embodiments, the separator comprises a glass microfiber or a polymer.

In one embodiment, the battery has an average peak capacity of 800-1100 mAH/g. In another embodiment, the average peak capacity is 984±119 mAH/g. In another embodiment, with current densities of from 0.1 to 1C and potential range of 1.6-2.8 V (vs Li/Li+).

In one embodiment, the battery has an average 100th cycle retention of 65-80%. In another embodiment, the average 100^{th} cycle retention is 72±8%.

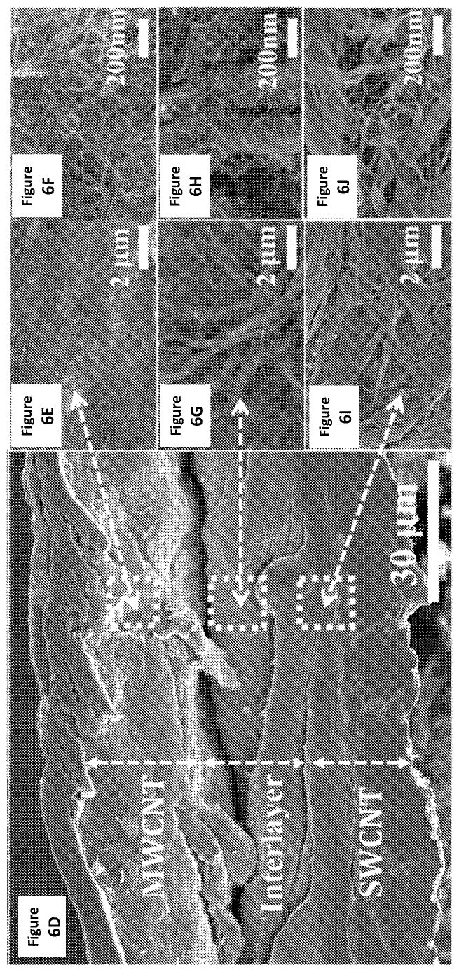

In some embodiments, the MWCNT side of the cathode within the battery faces the electrolyte, and the anode faces the other side of the electrolyte. In one embodiment, the separator is facing both sides of the electrolyte, so the separator is found between the anode and the electrode. In one embodiment, an example for the setup described above is illustrated in FIG. 4.

The cathodes of this invention demonstrate performance superior to that of the cathodes composed from SWCNT or MWCNT only. SWCNT component has a high surface area, enabling high sulfur loading and excellent connection between the non-conductive sulfur and the CNT network leading to enhanced electronic transport. It also features mechanical strength and flexibility, which are crucial in LSB (lithium sulfur batteries) operation due to the severe volume changes sulfur undergoes upon cycling. On the other hand, MWCNT component is characterized by advantageous mesopores structure that can provide efficient pathways for lithium-ion diffusion and electrolyte wettability within the pores and facilitate the immobilization of LiPS (lithium poly sulfide). This integration of the above components results in advantageous cathode characteristics. (see detailed comparison in examples below). Post-cycling characterization indicates that the composites of this invention stay mechanically intact and no major fracture appears over their surface, revealing good mechanical durability. Sulfur-containing composite takes advantage of the surface area, conductivity and mechanical properties of SWCNT together with superior porous morphology of MWCNT, leading to synergistic effect and well-disturbed sulfur-carbon network with enhanced electron transport, high durability, and mechanical robustness. Sulfur migration to MWCNT layer during cycling is observed, emphasizing the importance of the overall robustness. Some works (Walle, M. D.; Zeng, K.; Zhang, M.; Li, Y.; Liu, Y.-N. Flower-like Molybdenum Disulfide/Carbon Nanotubes Composites for High Sulfur Utilization and High-Performance Lithium-Sulfur Battery Cathodes. Applied Surface Science 2019, 473, 540-547. https://doi.org/10.1016/j.apsusc.2018.12.169; Shi, Z.; Feng, W.; Wang, X.; Li, M.; Song, C.; Chen, L. Catalytic Cobalt Phosphide Co2P/Carbon Nanotube Nanocomposite as Host Material for High Performance Lithium-Sulfur Battery Cathode. Journal of Alloys and Compounds 2021, 851, 156289. https://doi.org/10.1016/j.jallcom.2020.156289; and Fang, R.; Chen, K.; Sun, Z.; Wang, D.-W.; Li, F. Sulfur-Carbon Composite Cathodes. Modern Aspects of Electrochemistry 2022, 19-82. https://doi.org/10.1007/978-3-030-90899-7_2) indicate better peak capacities and/or cycling stability, yet the preparation processes of the cathodes often make use of expensive materials and/or complex synthesis protocols involving the use of strong acids or bases, high temperatures, etc., which present challenges to scale-up and may involve safety concerns. The preparation of the cathode of this invention is solution-based, expedient, and involves nontoxic and inexpensive materials. It is also highly modular, allowing for different configurations, and exhibits reliable performance as verified by studies on multiple cells (50 devices).

Aromatic Compounds within the Composites

In some embodiments, the composites of this invention further comprise an aromatic compound.

In one embodiment, the composite comprises at least one layer of multi-walled carbon nanotube, and at least one layer of single-walled carbon nanotube and the layers optionally further consists of an aromatic compound. In another embodiment, the single-walled carbon nanotube further consists of an aromatic compound. In another embodiment, the multi-walled carbon nanotube further consists of an aromatic compound. In another embodiment, the single-walled carbon nanotube does not consist of an aromatic compound. In another embodiment, the multi-walled carbon nanotube does not consist of an aromatic compound.

In one embodiment, the composite comprises at least one layer of multi-walled carbon nanotube, and at least one layer of single-walled carbon nanotube and the layers optionally further consist of an aromatic compound. In another embodiment, the single-walled carbon nanotube further consists of an aromatic compound. In another embodiment, the multi-walled carbon nanotube further consists of an aromatic compound. In another embodiment, the single-walled carbon nanotube does not consist of an aromatic compound. In another embodiment, the multi-walled carbon nanotube does not consist of an aromatic compound.

In some embodiments, the aromatic compound within the composites of this invention is at least one of perylene diimide, naphthalene diimide, phthalocyanine, anthraquinone, acridine, naphthalene disulfonic acid, caffeic acid, phenazine, indigo, rhodamine, phenothiazine, thymolphthalein, aramid, derivative thereof, salt thereof or any combination thereof.

In some embodiments, the perylene diimide derivative is ethyl propyl perylene diimide.

In some embodiments, the anthraquinone derivative is a dihydroxy or trihydroxy anthraquinone. In one embodiment, the anthraquinone derivative is purpurin or alizarin.

In some embodiments, the acridine derivative is acridine orange.

In some embodiments, the phenazine derivative is safranin.

In some embodiments, the naphthalene disulfonic acid derivative salt is selected from the group consisting of chromatropic acid disodium salt, 2,6-naphthalenedisulfonic acid sodium salt, 2,7-naphthalenedisulfonic acid sodium salt, 2-(4-nitrophenylazo) chromotropic acid disodium salt (Chromotrope 2B), tetrasodium 4-amino-5-hydroxy-3,6-bis [[4-[[2-(sulphonatooxy)ethyl]sulphonyl]phenyl]azo]naphthalene-2,7-disulphonate (Reactive Black 5), and any combination thereof.

In some embodiments, the caffeic acid derivative comprises a caffeic ester or a caffeic amide.

In some embodiments, the indigo derivative comprises indigo carmine. In some other embodiments, the indigo derivative comprises rhodamine 101 inner salt.

In some embodiments, the phenothiazine derivative comprises methylene blue.

In some embodiments, the term “derivative thereof” comprises a chemical modification of any one of the listed aromatic compounds with one or more functional groups or with any chemical group (i.e, hydroxyl, alkyl, aryl, halide, nitro, amine, ester, amide, carboxylic acid or combination thereof). For example, by derivatizing anthraquinone with hydroxyl groups (alizarin, purpurin) a hydrophilic hybrid is obtained. By derivatizing anthraquinone with hydrophobic groups (C6-C10 alkyls), a hydrophobic hybrid is obtained. Each possibility represents a separate embodiment of this invention.

In some embodiments, the salts of any one of the listed aromatic compounds is an organic or inorganic acid salt or an organic or inorganic basic salt. Each possibility represents a separate embodiment of this invention.

Suitable acid salts comprising an inorganic acid or an organic acid. In one embodiment, examples of inorganic acid salts are bisulfates, borates, bromides, chlorides, hemisulfates, hydrobromates, hydrochlorates, 2-hydroxyethylsulfonates (hydroxyethanesulfonates), iodates, iodides, isothionates, nitrate, persulfates, phosphate, sulfates, sulfamates, sulfanilates, sulfonic acids (alkylsulfonates, arylsulfonates, halogen substituted alkylsulfonates, halogen substituted arylsulfonates), sulfonates and thiocyanates. Each possibility represents a separate embodiment of this invention.

In one embodiment, examples of organic acid salts may be selected from aliphatic, cycloaliphatic, aromatic, araliphatic, heterocyclic, carboxylic and sulfonic classes of organic acids, examples of which are acetates, arginines, aspartates, ascorbates, adipates, anthranilate, algenate, alkane carboxylates, substituted alkane carboxylates, alginates, benzenesulfonates, benzoates, bisulfates, butyrates, bicarbonates, bitartrates, carboxilate, citrates, camphorates, camphorsulfonates, cyclohexylsulfamates, cyclopentanepropionates, calcium edetates, camsylates, carbonates, clavulanates, cinnamates, dicarboxylates, digluconates, dodecylsulfonates, dihydrochlorides, decanoates, enanthuates, ethanesulfonates, edetates, edisylates, estolates, esylates, fumarates, formates, fluorides, galacturonate gluconates, glutamates, glycolates, glucorate, glucoheptanoates, glycerophosphates, gluceptates, glycollylarsanilates, glutarates, glutamate, heptanoates, hexanoates, hydroxymaleates, hydroxycarboxlic acids, hexylresorcinates, hydroxybenzoates, hydroxynaphthoate, hydrofluorate, lactates, lactobionates, laurates, malates, maleates, methylenebis(beta-oxynaphthoate), malonates, mandelates, mesylates, methane sulfonates, methylbromides, methylnitrates, methylsulfonates, monopotassium maleates, mucates, monocarboxylates, mitrates, naphthalenesulfonates, 2-naphthalenesulfonates, nicotinates, napsylates, N-methylglucamines, oxalates, octanoates, oleates, pamoates, phenylacetates, picrates, phenylbenzoates, pivalates, propionates, phthalates, phenylacetate, pectinates, phenylpropionates, palmitates, pantothenates, polygalacturates, pyruvates, quinates, salicylates, succinates, stearates, sulfanilate, subacetates, tartarates, theophyllineacetates, p-toluenesulfonates (tosylates), trifluoroacetates, terephthalates, tannates, teoclates, trihaloacetates, triethiodide, tricarboxylates, undecanoates and valerates. Each possibility represents a separate embodiment of this invention.

In one embodiment, examples of inorganic basic salts may be selected from ammonium, alkali metals to include lithium, sodium, potassium, cesium; alkaline earth metals to include calcium, magnesium, aluminium; zinc, barium, cholines, quaternary ammoniums. Each possibility represents a separate embodiment of this invention.

In another embodiment, examples of organic basic salts may be selected from arginine, organic amines to include aliphatic organic amines, alicyclic organic amines, aromatic organic amines, benzathines, t-butylamines, benethamines (N-benzylphenethylamine), dicyclohexylamines, dimethylamines, diethanolamines, ethanolamines, ethylenediamines, hydrabamines, imidazoles, lysines, methylamines, meglamines, N-methyl-D-glucamines, N,N′-dibenzylethylenediamines, nicotinamides, organic amines, ornithines, pyridines, picolies, piperazines, procain, tris(hydroxymethyl)methylamines, triethylamines, triethanolamines, trimethylamines, tromethamines and ureas. Each possibility represents a separate embodiment of this invention.

### Perylene Diimide Derivatives

In some embodiments, the perylene diimide derivative is represented by the structure of formula IA or IB:

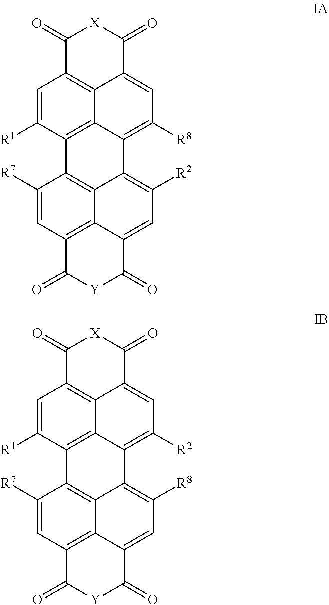

wherein,
X is —NR³;
Y is —NR⁴;
R¹ is H, R⁵, (C₁-C₁₀)alkyl, (C₁-C₁₀)haloalkyl, (C₃-C₅)cycloalkyl, aryl or heteroaryl, wherein said alkyl, haloalkyl, cycloalkyl, aryl or heteroaryl groups are optionally substituted; or R¹ is joined together with R⁷ to form a substituted or unsubstituted five or six membered ring, or a substituted or unsubstituted five or six membered fused ring;
R² is H, R⁵, (C₁-C₁₀)alkyl, (C₁-C₁₀)haloalkyl, (C₃-C₈)cycloalkyl, aryl or heteroaryl, wherein said alkyl, haloalkyl, cycloalkyl, aryl or heteroaryl groups are optionally substituted; or R² is joined together with R⁸ to form a substituted or unsubstituted five or six membered ring, or a substituted or unsubstituted five or six membered fused ring;
R³ and R⁴ are each independently H, (C₁-C₁₀)alkyl, (C₁-C₁₀)haloalkyl, (C₃-C₈)cycloalkyl, aryl or heteroaryl, wherein said alkyl, haloalkyl, cycloalkyl, aryl or heteroaryl groups are optionally substituted;
R⁵ is OR⁶, OCH₃, CF₃, halide, COR⁶, COCl, COOCOR⁶, COOR⁶, OCOR⁶, OCONHR⁶, NHCOOR⁶, NHCONHR⁶, OCOOR⁶, CON(R⁶)₂, SR⁶, SO₂R⁶, SO₂M, SOR⁶, SO₃H, SO₃M, SO₂NH₂, SO₂NH(R⁶), SO₂N(R⁶)₂, NH₂, NH(R⁶), N(R⁶)₂, CONH₂, CONH(R⁶), CON(R⁶)₂, CO(N-heterocycle), NO₂, OH, CN, cyanate, isocyanate, thiocyanate, isothiocyanate, mesylate, tosylate, triflate, PO(OH)₂ or OPO(OH)₂; wherein M is a monovalent cation;
R⁶ is H, (C₁-C₁₀)alkyl, (C₁-C₁₀)haloalkyl, (C₃-C₈)cycloalkyl, aryl or heteroaryl, wherein said alkyl, haloalkyl, cycloalkyl, aryl or heteroaryl groups are optionally substituted;
R⁷ is H or is joined together with R¹ to form a substituted or unsubstituted five or six membered ring, or a substituted or unsubstituted five or six membered fused ring; and
R⁸ is H or is joined together with R² to form a substituted or unsubstituted five or six membered ring, or a substituted or unsubstituted five or six membered fused ring.

In some embodiments, the perylene diimide derivative is represented by the structure of formula II:

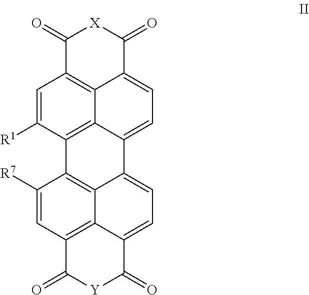

wherein,
X is —NR³;
Y is —NR⁴;
R¹ is H, R⁵, (C₁-C₁₀)alkyl, (C₁-C₁₀)haloalkyl, (C₃-C₈)cycloalkyl, aryl or heteroaryl, wherein said alkyl, haloalkyl, cycloalkyl, aryl or heteroaryl groups are optionally substituted; or R¹ is joined together with R⁷ to form a substituted or unsubstituted five or six membered ring, or a substituted or unsubstituted five or six membered fused ring;
R³ and R⁴ are each independently H, (C₁-C₁₀)alkyl, (C₁-C₁₀)haloalkyl, (C₃-C₈)cycloalkyl, aryl or heteroaryl, wherein said alkyl, haloalkyl, cycloalkyl, aryl or heteroaryl groups are optionally substituted;
R⁵ is OR⁶, OCH₃, CF₃, halide, COR⁶, COCl, COOCOR⁶, COOR⁶, OCOR⁶, OCONHR⁶, NHCOOR⁶, NHCONHR⁶, OCOOR⁶, CON(R⁶)₂, SR⁶, SO₂R⁶, SO₂M, SOR⁶, SO₃H, SO₃M, SO₂NH₂, SO₂NH(R⁶), SO₂N(R⁶)₂, NH₂, NH(R⁶), N(R⁶)₂, CONH₂, CONH(R⁶), CON(R⁶)₂, CO(N-heterocycle), NO₂, OH, CN, cyanate, isocyanate, thiocyanate, isothiocyanate, mesylate, tosylate, triflate, PO(OH)₂ or OPO(OH) 2; wherein M is a monovalent cation;
R⁶ is H, (C₁-C₁₀)alkyl, (C₁-C₁₀)haloalkyl, (C₃-C₈)cycloalkyl, aryl or heteroaryl, wherein said alkyl, haloalkyl, cycloalkyl, aryl or heteroaryl groups are optionally substituted; and
R⁷ is H or joined together with R¹ to form a substituted or unsubstituted five or six membered ring, or a substituted or unsubstituted five or six membered fused ring.

In some embodiments, the perylene diimide derivative is represented by the structure of formula III:

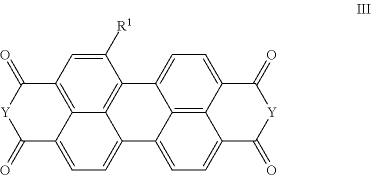

wherein,
X is —NR³;
Y is —NR⁴;
R¹ is H, (C₁-C₁₀)alkyl, (C₁-C₁₀)haloalkyl, (C₃-C₈)cycloalkyl, aryl or heteroaryl, wherein said alkyl, haloalkyl, cycloalkyl, aryl or heteroaryl groups are optionally substituted or R⁵;
R³ and R⁴ are each independently H, (C₁-C₁₀)alkyl, (C₁-C₁₀)haloalkyl, (C₃-C₈)cycloalkyl, aryl or heteroaryl, wherein said alkyl, haloalkyl, cycloalkyl, aryl or heteroaryl groups are optionally substituted;
R⁵ is OR⁶, OCH₃, CF₃, halide, COR⁶, COCl, COOCOR⁶, COOR⁶, OCOR⁶, OCONHR⁶, NHCOOR⁶, NHCONHR⁶, OCOOR⁶, CN, CON(R⁶)₂, SR⁶, SO₂R⁶, SO₂M, SOR⁶ SO₃H, SO₃M SO₂NH₂, SO₂NH(R⁶), SO₂N(R⁶)₂, NH₂, NH(R⁶), N(R⁶)₂, CONH₂, CONH(R⁶), CON(R⁶)₂, CO(N-heterocycle), C(O)(C₁-C₁₀)alkyl, NO₂, CN, cyanate, isocyanate, thiocyanate, isothiocyanate, mesylate, tosylate, triflate, PO(OH)₂ or OPO(OH) 2;
R⁶ is H, (C₁-C₁₀)alkyl, (C₁-C₁₀)haloalkyl, (C₃-C₈)cycloalkyl, aryl or heteroaryl, wherein said alkyl, haloalkyl, cycloalkyl, aryl or heteroaryl groups are optionally substituted; and
M is a monovalent cation.

In other embodiments, the perylene diimide derivative is represented by the structure of 1′, 2a′, 2b′, 3′ or 4′:

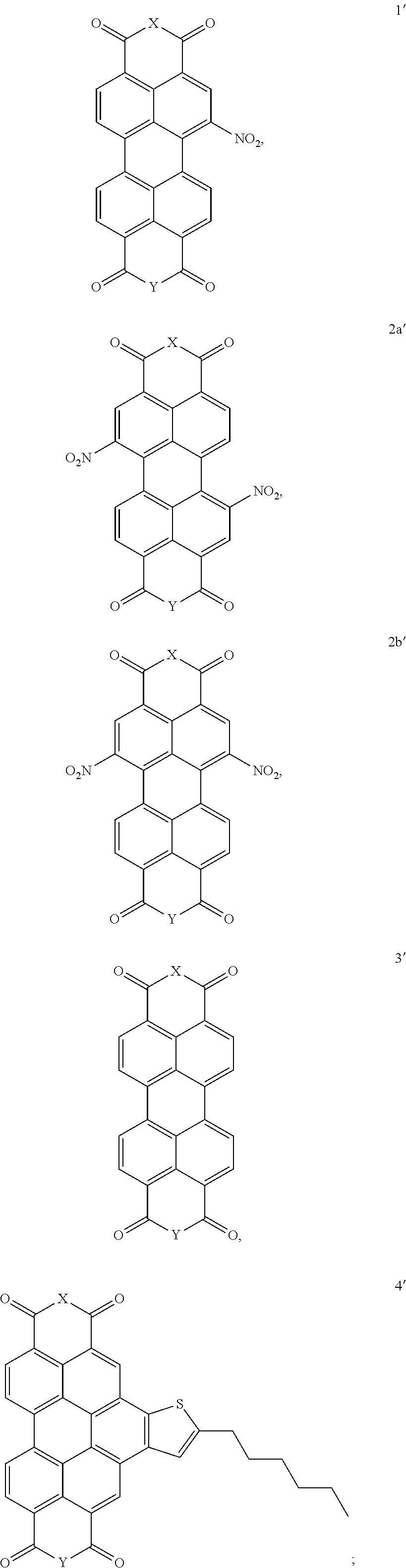

wherein;
X is —NR³;
Y is —NR⁴; and
R³ and R⁴ are each independently H, (C₁-C₁₀)alkyl, (C₁-C₁₀)haloalkyl, (C₃-C₈)cycloalkyl, aryl or heteroaryl, wherein said alkyl, haloalkyl, cycloalkyl, aryl or heteroaryl groups are optionally substituted.

In some embodiments, the free-standing film of this invention comprises one or more different perylene diimide derivatives. In other embodiments the free-standing film comprises 2, 3, 4, 5 different perylene diimide derivatives. Each represents a separate embodiment of this invention.

In some embodiments, R¹ is H, (C₁-C₁₀)alkyl, (C₁-C₁₀)haloalkyl, (C₃-C₈)cycloalkyl, aryl or heteroaryl, OR⁶, OCH₃, CF₃, halide, F, COR⁶, COCl, COOCOR⁶, COOR⁶, OCOR⁶, OCONHR⁶, NHCOOR⁶, NHCONHR⁶, OCOOR⁶, CN, CON(R⁶)₂, SR⁶, SO₂R⁶, SO₂M, SOR⁶, SO₃H, SO₃M SO₂NH₂, SO₂NH(R⁶), SO₂N(R⁶)₂, NH₂, NH(R⁶), N(R⁶)₂, CONH₂, CONH(R⁶), CON(R⁶)₂, CO(N-heterocycle), C(O)(C₁-C₁₀)alkyl, NO₂, CN, cyanate, isocyanate, thiocyanate, isothiocyanate, mesylate, tosylate, triflate, PO(OH)₂, OPO(OH)₂ or R¹ is joined together with R⁷ to form a substituted or unsubstituted five or six membered ring, or a substituted or unsubstituted five or six membered fused ring; wherein said alkyl, haloalkyl, cycloalkyl, aryl or heteroaryl groups are optionally substituted; and each represents a separate embodiment of this invention. In other embodiments R¹ is H. In other embodiments R¹ is NO₂. In other embodiments R¹ is OMe.

In some embodiments, R² is H, (C₁-C₁₀)alkyl, (C₁-C₁₀)haloalkyl, (C₃-C₈)cycloalkyl, aryl or heteroaryl, OR⁶, OCH₃, CF₃, halide, F, COR⁶, COCl, COOCOR⁶, COOR⁶, OCOR⁶, OCONHR⁶, NHCOOR⁶, NHCONHR⁶, OCOOR⁶, CN, CON(R⁶)₂, SR⁶, SO₂R⁶, SO₂M, SOR⁶, SO₃H, SO₃M SO₂NH₂, SO₂NH(R⁶), SO₂N(R⁶)₂, NH₂, NH(R⁶), N(R⁶)₂, CONH₂, CONH(R⁶), CON(R⁶)₂, CO(N-heterocycle), C(O)(C₁-C₁₀)alkyl, NO₂, CN, cyanate, isocyanate, thiocyanate, isothiocyanate, mesylate, tosylate, triflate, PO(OH)₂, OPO(OH)₂ or R² is joined together with R⁸ to form a substituted or unsubstituted five or six membered ring, or a substituted or unsubstituted five or six membered fused ring; wherein said alkyl, haloalkyl, cycloalkyl, aryl or heteroaryl groups are optionally substituted; and each represents a separate embodiment of this invention. In other embodiments R² is H. In other embodiments R² is NO₂. In other embodiments R² is OMe.

In some embodiments, R³ and R⁴ are each independently H, (C₁-C₁₀)alkyl, (C₁-C₁₀)haloalkyl, (C₃-C₈)cycloalkyl, aryl or heteroaryl, wherein said alkyl, haloalkyl, cycloalkyl, aryl or heteroaryl groups are optionally substituted. Each represents a separate embodiment of this invention.

In some embodiments, R¹, R², R³, R⁴ and R⁶ are each independently (C₁-C₁₀)alkyl, (C₁-C₁₀)haloalkyl, (C₃-C₈)cycloalkyl, aryl or heteroaryl. In other embodiments, R¹, R², R³, R⁴ and R⁶ are each independently (C₁-C₁₀)alkyl. In other embodiments, the (C₁-C₁₀)alkyl is methyl, ethyl, propyl, isopropyl, butyl, t-butyl, pentyl, neopentyl, 3-pentyl, sec-pentyl, tert-pentyl, iso-pentyl, hexyl, or heptyl, each represents a separate embodiment of this invention. In other embodiments, R¹, R², R³, R⁴ and R⁶ are each independently is (C₁-C₁₀)haloalkyl. In another embodiment, the (C₁-C₁₀)haloalkyl is CF₃, CF₂CF₃, iodomethyl, bromomethyl, bromoethyl, bromopropyl, each represents a separate embodiment of the invention. In other embodiments, R¹, R², R³, R⁴ and R⁶ are each independently is (C₃-C₈)cycloalkyl. In other embodiments, (C₃-C₈)cycloalkyl is cyclopropyl, cyclobutyl, cyclopentyl, cyclohexyl, cycloheptyl; each represents a separate embodiment of this invention. In various embodiments, the alkyl, haloalkyl, cycloalkyl, aryl or heteroaryl of R¹, R², R³, R⁴ and R⁶ are further substituted by one or more groups selected from: halide, CN, CO₂H, OH, SH, NH₂, NO₂, CO₂—(C₁-C₆ alkyl) or O—(C₁-C₆ alkyl); each represents a separate embodiment of this invention.

In some embodiments, R¹, R² and/or R⁵ is OR⁶, OCH₃, CF₃, halide, F, COR⁶, COCl, COOCOR⁶, COOR⁶, OCOR⁶, OCONHR⁶, NHCOOR⁶, NHCONHR⁶, OCOOR⁶, CN, CON(R⁶)₂, SR⁶, SO₂R⁶, SO₂M, SOR⁶ SO₃H, SO₃M SO₂NH₂, SO₂NH(R⁶), SO₂N(R⁶)₂, NH₂, NH(R⁶), N(R⁶)₂, CONH₂, CONH(R⁶), CON(R⁶)₂, CO(N-heterocycle), C(O)(C₁-C₁₀)alkyl, NO₂, CN, cyanate, isocyanate, thiocyanate, isothiocyanate, mesylate, tosylate, triflate, PO(OH)₂ or OPO(OH)₂; wherein M is a monovalent cation; each represents a separate embodiment of this invention.

In other embodiments, R¹, R² and/or R⁵ is OR⁶. In other embodiments, OR⁶ is methoxy, ethoxy, propoxy, iso-propoxy, butoxy, t-butoxy, each represents a separate embodiment of this invention. In other embodiments, R¹, R² and/or R⁵ is OCH₃. In other embodiments, R¹, R² and/or R⁵ is CF₃. In other embodiments R¹, R² and/or R⁵ is halide. In other embodiments, R¹, R² and/or R⁵ is F.

In other embodiments, R¹, R² and/or R⁵ is COR⁶. In other embodiments, COR⁶ is CO((C₁-C₁₀)alkyl). In other embodiments, CO((C₁-C₁₀)alkyl) is COCH₃, COCH₂CH₃, COCH₂CH₂CH₃, COCH(CH₃)₂, COCH₂CH₂CH₂CH₃, COC(CH₃)₃, COCH₂CH₂CH₂CH₂CH₃, COCH₂C(CH₃)₃, COCH(CH₂CH₃)₂, COCH(CH₃) (CH₂CH₂CH₃), COCH(CH₃)₂(CH₂CH₃), COCH₂CH₂CH(CH₃)₂, COCH₂CH₂CH₂CH₂CH₂CH₃ or COCH₂CH₂CH₂CH₂CH₂CH₂CH₃, each represents a separate embodiment of this invention. In other embodiments, COR⁶ is CO((C₁-C₁₀)haloalkyl). In other embodiments, CO((C₁-C₁₀)haloalkyl) is COCF₃, COCF₂CF₃, COCH₂I, COCH₂Br, COCH₂CH₂Br, COCHBrCH₃, COCH₂CH₂CH₂Br, COCH₂CHBrCH₃ or COCHBrCH₂CH₃, each represents a separate embodiment of the invention. In other embodiments, COR⁶ is a CO((C₃-C₈)cycloalkyl). In other embodiments, CO((C₃-C₈)cycloalkyl) is CO(cyclobutyl), CO(cyclopentyl) or CO(cyclohexyl), each represents a separate embodiment of the invention. In other embodiments, COR⁴ is a CO(aryl). In other embodiments, CO(aryl) is CO(phenyl), CO(naphtyl) or CO(perylenyl), each represents a separate embodiment of the invention. In other embodiments, COR⁶ is a CO(heteroaryl). In other embodiments, CO(heteroaryl) is CO(pyranyl), CO(pyrrolyl), CO(pyrazinyl), CO(pyrimidinyl), CO(pyrazolyl), CO(pyridinyl), CO(furanyl), CO(thiophenyl), CO(thiazolyl), CO(indolyl), CO(imidazolyl), CO(isoxazolyl), each represents a separate embodiment of the invention. In other embodiments, R¹, R² and/or R⁵ is COCl. In other embodiments, R¹, R² and/or R⁵ is COOCOR⁴. In other embodiments, COOCOR⁶ is COOCO((C₁-C₁₀)alkyl). In other embodiments, COOCO((C₁-C₁₀)alkyl) is COOCOCH₃, COOCOCH₂CH₃, COOCOCH₂CH₂CH₃, COOCOCH(CH₃)₂, COOCOCH₂CH₂CH₂CH₃, COOCOC(CH₃)₃, COOCOCH₂CH₂CH₂CH₂CH₃, COOCOCH₂C(CH₃)₃, COOCOCH(CH₂CH₃)₂, COOCOCH(CH₃) (CH₂CH₂CH₃) COOCOCH(CH₃)₂(CH₂CH₃), COOCOCH₂CH₂CH(CH₃)₂, COOCOCH₂CH₂CH₂CH₂CH₂CH₃ or COOCOCH₂CH₂CH₂CH₂CH₂CH₂CH₃, each represents a separate embodiment of this invention. In other embodiments, COOCOR⁶ is COOCO((C₁-C₁₀)haloalkyl). In other embodiments, COOCO((C₁-C₁₀)haloalkyl) is COOCOCF₃, COOCOCF₂CF₃, COOCOCH₂I, COOCOCH₂Br, COOCOCH₂CH₂Br, COOCOCHBrCH₃, COOCOCH₂CH₂CH₂Br, COOCOCH₂CHBrCH₃ or COOCOCHBrCH₂CH₃, each represents a separate embodiment of the invention. In other embodiments, COOCOR⁶ is a COOCO((C₃-C₅)cycloalkyl). In another embodiment, COOCO((C₃-C₈)cycloalkyl) is COOCO(cyclobutyl), COOCO(cyclopentyl) or COOCO(cyclohexyl), each represents a separate embodiment of the invention. In other embodiments, COOCOR⁶ is a COOCO(aryl). In another embodiment, COOCO(aryl) is COOCO(phenyl), COOCO(naphtyl) or COOCO(perylenyl), each represents a separate embodiment of the invention. In other embodiments, COOCOR⁶ is a COOCO(heteroaryl). In other embodiments, COOCO(heteroaryl) is COOCO(pyranyl), COOCO(pyrrolyl), COOCO(pyrazinyl), COOCO(pyrimidinyl), COOCO(pyrazolyl), COOCO(pyridinyl), COOCO(furanyl), COOCO(thiophenyl), COOCO(thiazolyl), COOCO(indolyl), COOCO(imidazolyl), COOCO(isoxazolyl), each represents a separate embodiment of the invention.

In another embodiment, R¹, R² and/or R⁵ is COOR⁶. In other embodiments, COOR⁶ is COO(C₁-C₁₀)alkyl. In other embodiments, COO(C₁-C₁₀)alkyl is COOCH₃, COOCH₂CH₃, COOCH₂CH₂CH₃, COOCH(CH₃)₂, COOCH₂CH₂CH₂CH₃, COOC(CH₃)₃, COOCH₂CH₂CH₂CH₂CH₃, COOCH₂C(CH₃) 3 COOCH(CH₂CH₃)₂, COOCH(CH₃) (CH₂CH₂CH₃) COOCH(CH₃)₂(CH₂CH₃), COOCH₂CH₂CH(CH₃)₂, COOCH₂CH₂CH₂CH₂CH₂CH₃ or COOCH₂CH₂CH₂CH₂CH₂CH₂CH₃, each represents a separate embodiment of this invention. In other embodiments, COOR⁶ is COO(C₁-C₁₀)haloalkyl. In other embodiments, COO(C₁-C₁₀)haloalkyl is COOCF₃, COOCF₂CF₃, COOCH₂I, COOCH₂Br, COOCH₂CH₂Br, COOCHBrCH₃, COOCH₂CH₂CH₂Br, COOCH₂CHBrCH₃ or COOCHBrCH₂CH₃, each represents a separate embodiment of the invention. In other embodiments, COOR⁴ is a COO(C₃-C₈)cycloalkyl. In other embodiments, COO(C₃-C₈)cycloalkyl is COO(cyclobutyl), COO(cyclopentyl) or COO(cyclohexyl), each represents a separate embodiment of the invention. In other embodiments, COOR⁶ is a OCO(aryl). In other embodiments, COO(aryl) is COO(phenyl), COO(naphtyl) or COO(perylenyl), each represents a separate embodiment of the invention. In another embodiment, COOR⁶ is a COO(heteroaryl). In other embodiments, COO(heteroaryl) is COO(pyranyl), COO(pyrrolyl), COO(pyrazinyl), COO(pyrimidinyl), COO(pyrazolyl), COO(pyridinyl), COO(furanyl), COO(thiophenyl), COO(thiazolyl), COO(indolyl), COO(imidazolyl), COO(isoxazolyl), each represents a separate embodiment of the invention.

In another embodiment, R¹, R² and/or R⁵ is OCOR⁶. In other embodiments, OCOR⁶ is OCO((C₁-C₁₀)alkyl). In other embodiments, OCO((C₁-C₁₀)alkyl) is OCOCH₃, OCOCH₂CH₃, OCOCH₂CH₂CH₃, OCOCH(CH₃)₂, OCOCH₂CH₂CH₂CH₃, OCOC(CH₃)₃, OCOCH₂CH₂CH₂CH₂CH₃, OCOCH₂C(CH₃)₃, OCOCH(CH₂CH₃)₂, OCOCH(CH₃) (CH₂CH₂CH₃), OCOCH(CH₃)₂(CH₂CH₃), OCOCH₂CH₂CH(CH₃)₂, OCOCH₂CH₂CH₂CH₂CH₂CH₃ or OCOCH₂CH₂CH₂CH₂CH₂CH₂CH₃, each represents a separate embodiment of this invention. In other embodiments, OCOR⁶ is OCO((C₁-C₁₀)haloalkyl). In other embodiments, OCO((C₁-C₁₀)haloalkyl) is OCOCF₃, OCOCF₂CF₃, OCOCH₂I, OCOCH₂Br, OCOCH₂CH₂Br, OCOCHBrCH₃, OCOCH₂CH₂CH₂Br, OCOCH₂CHBrCH₃ or OCOCHBrCH₂CH₃, each represents a separate embodiment of the invention. In other embodiments, OCOR⁶ is a OCO((C₃-C₈)cycloalkyl). In other embodiments, OCO((C₃-C₈)cycloalkyl) is OCO(cyclobutyl), OCO(cyclopentyl) or OCO(cyclohexyl), each represents a separate embodiment of the invention. In other embodiments, OCOR⁶ is a OCO(aryl). In other embodiments, OCO(aryl) is OCO(phenyl), OCO(naphtyl) or OCO(perylenyl), each represents a separate embodiment of the invention. In another embodiment, OCOR⁶ is a OCO(heteroaryl). In another embodiment, OCO(heteroaryl) is OCO(pyranyl), OCO(pyrrolyl), OCO(pyrazinyl), OCO(pyrimidinyl), OCO(pyrazolyl), OCO(pyridinyl), OCO(furanyl), OCO(thiophenyl), OCO(thiazolyl), OCO(indolyl), OCO(imidazolyl), OCO(isoxazolyl), each represents a separate embodiment of the invention.

In other embodiments, R¹, R² and/or R⁵ is OCONHR⁶. In other embodiments, OCONHR⁶ is OCONH((C₁-C₁₀)alkyl). In other embodiments, OCONH((C₁-C₁₀)alkyl) is OCONHCH₃, OCONHCH₂CH₃, OCONHCH₂CH₂CH₃, OCONHCH(CH₃)₂, OCONHCH₂CH₂CH₂CH₃, OCONHC(CH₃)₃, OCONHCH₂CH₂CH₂CH₂CH₃, OCONHCH₂C(CH₃)₃, OCONHCH(CH₂CH₃)₂, OCONHCH(CH₃)(CH₂CH₂CH₃), OCONHCH(CH₃)₂(CH₂CH₃), OCONHCH₂CH₂CH(CH₃)₂, OCONHCH₂CH₂CH₂CH₂CH₂CH₃ or OCONHCH₂CH₂CH₂CH₂CH₂CH₂CH₃, each represents a separate embodiment of this invention. In other embodiments, OCONHR⁶ is OCONH((C₁-C₁₀)haloalkyl). In other embodiments, OCONH((C₁-C₁₀)haloalkyl) is OCONHCF₃, OCONHCF₂CF₃, OCONHCH₂I, OCONHCH₂Br, OCONHCH₂CH₂Br, OCONHCHBrCH₃, OCONHCH₂CH₂CH₂Br, OCONHCH₂CHBrCH₃ or OCONHCHBrCH₂CH₃, each represents a separate embodiment of the invention. In other embodiments, OCONHR⁶ is a OCONH((C₃-C₈)cycloalkyl). In other embodiments, OCONH((C₃-C₈)cycloalkyl) is OCONH(cyclobutyl), OCONH(cyclopentyl) or OCONH(cyclohexyl), each represents a separate embodiment of the invention. In other embodiments, OCONHR⁶ is a OCONH(aryl). In other embodiments, OCONH(aryl) is OCONH(phenyl), OCONH(naphtyl) or OCONH(perylenyl), each represents a separate embodiment of the invention. In other embodiments, OCONHR⁶ is a OCONH(heteroaryl). In other embodiments, OCONH(heteroaryl) is OCONH(pyranyl), OCONH(pyrrolyl), OCONH(pyrazinyl), OCONH(pyrimidinyl), OCONH(pyrazolyl), OCONH(pyridinyl), OCONH(furanyl), OCONH(thiophenyl), OCONH(thiazolyl), OCONH(indolyl), OCONH(imidazolyl), OCONH(isoxazolyl), each represents a separate embodiment of the invention.

In other embodiments, R¹, R² and/or R⁵ is NHCOOR⁶. In other embodiments, NHCOOR⁶ is NHCOO((C₁-C₁₀)alkyl). In other embodiments, NHCOO((C₁-C₁₀)alkyl) is NHCOOCH₃, NHCOOCH₂CH₃, NHCOOCH₂CH₂CH₃, NHCOOCH(CH₃)₂, NHCOOCH₂CH₂CH₂CH₃, NHCOOC(CH₃)₃, NHCOOCH₂CH₂CH₂CH₂CH₃, NHCOOCH₂C(CH₃) 3 NHCOOCH(CH₂CH₃)₂, NHCOOCH(CH₃) (CH₂CH₂CH₃), NHCOOCH(CH₃)₂(CH₂CH₃), NHCOOCH₂CH₂CH(CH₃)₂, NHCOOCH₂CH₂CH₂CH₂CH₂CH₃ or NHCOOCH₂CH₂CH₂CH₂CH₂CH₂CH₃, each represents a separate embodiment of this invention. In other embodiments, NHCOOR⁶ is NHCOO((C₁-C₁₀)haloalkyl). In other embodiments, NHCOO((C₁-C₁₀)haloalkyl) is NHCOOCF₃, NHCOOCF₂CF₃, NHCOOCH₂I, NHCOOCH₂Br, NHCOOCH₂CH₂Br, NHCOOCHBrCH₃, NHCOOCH₂CH₂CH₂Br, NHCOOCH₂CHBrCH₃ or NHCOOCHBrCH₂CH₃, each represents a separate embodiment of the invention. In other embodiments, NHCOOR⁶ is a NHCOO((C₃-C₈)cycloalkyl). In another embodiment, NHCOO((C₃-C₈)cycloalkyl) is NHCOO(cyclobutyl), NHCOO(cyclopentyl) or NHCOO(cyclohexyl), each represents a separate embodiment of the invention. In other embodiments, NHCOOR⁶ is a NHCOO(aryl). In other embodiments, NHCOO(aryl) is NHCOO(phenyl), NHCOO(naphtyl) or NHCOO(perylenyl), each represents a separate embodiment of the invention. In other embodiments, NHCOOR⁶ is a NHCOO(heteroaryl). In other embodiments, NHCOO(heteroaryl) is NHCOO(pyranyl), NHCOO(pyrrolyl), NHCOO(pyrazinyl), NHCOO(pyrimidinyl), NHCOO(pyrazolyl), NHCOO(pyridinyl), NHCOO (furanyl), NHCOO(thiophenyl), NHCOO(thiazolyl), NHCOO(indolyl), NHCOO(imidazolyl), NHCOO(isoxazolyl), each represents a separate embodiment of the invention.

In another embodiment, R¹, R² and/or R⁵ is NHCONHR⁶. In other embodiments, NHCONHR⁶ is NHCONH((C₁-C₁₀)alkyl). In other embodiments, NHCONH((C₁-C₁₀)alkyl) is NHCONHCH₃, NHCONHCH₂CH₃, NHCONHCH₂CH₂CH₃, NHCONHCH(CH₃)₂, NHCONHCH₂CH₂CH₂CH₃, NHCONHC(CH₃)₃, NHCONHCH₂CH₂CH₂CH₂CH₃, NHCONHCH₂C(CH₃)₃, NHCONHCH(CH₂CH₃)₂, NHCONHCH(CH₃) (CH₂CH₂CH₃) NHCONHCH(CH₃)₂(CH₂CH₃), NHCONHCH₂CH₂CH(CH₃)₂, NHCONHCH₂CH₂CH₂CH₂CH₂CH₃ or NHCONHCH₂CH₂CH₂CH₂CH₂CH₂CH₃, each represents a separate embodiment of this invention. In other embodiments, NHCONHR⁶ is NHCONH((C₁-C₁₀)haloalkyl). In other embodiments, NHCONH((C₁-C₁₀)haloalkyl) is NHCONHCF₃, NHCONHCF₂CF₃, NHCONHCH₂I, NHCONHCH₂Br, NHCONHCH₂CH₂Br, NHCONHCHBrCH₃, NHCONHCH₂CH₂CH₂Br, NHCONHCH₂CHBrCH₃ or NHCONHCHBrCH₂CH₃, each represents a separate embodiment of the invention. In other embodiments, NHCONHR⁶ is a NHCONH((C₃-C₈)cycloalkyl). In other embodiments, NHCONH((C₃-C₈)cycloalkyl) is NHCONH(cyclobutyl), NHCONH(cyclopentyl) or NHCONH (cyclohexyl), each represents a separate embodiment of the invention. In other embodiments, NHCONHR⁴ is a NHCONH(aryl). In other embodiments, NHCONH(aryl) is NHCONH(phenyl), NHCONH(naphtyl) or NHCONH(perylenyl), each represents a separate embodiment of the invention. In other embodiments, NHCONHR⁶ is a NHCONH(heteroaryl). In other embodiments, NHCONH(heteroaryl) is NHCONH(pyranyl), NHCONH(pyrrolyl), NHCONH(pyrazinyl), NHCONH(pyrimidinyl), NHCONH(pyrazolyl), NHCONH(pyridinyl), NHCONH(furanyl), NHCONH(thiophenyl), NHCONH(thiazolyl), NHCONH(indolyl), NHCONH(imidazolyl), NHCONH(isoxazolyl), each represents a separate embodiment of the invention.

In another embodiment, R¹, R² and/or R⁵ is OCOOR⁶. In other embodiments, OCOOR⁶ is OCOO((C₁-C₁₀)alkyl). In other embodiments, OCOO((C₁-C₁₀)alkyl) is OCOOCH₃, OCOOCH₂CH₃, OCOOCH₂CH₂CH₃, OCOOCH(CH₃)₂, OCOOCH₂CH₂CH₂CH₃, OCOOC(CH₃)₃, OCOOCH₂CH₂CH₂CH₂CH₃, OCOOCH₂C(CH₃)₃, OCOOCH(CH₂CH₃)₂, OCOOCH(CH₃) (CH₂CH₂CH₃), OCOOCH(CH₃)₂(CH₂CH₃), OCOOCH₂CH₂CH(CH₃) 2 OCOOCH₂CH₂CH₂CH₂CH₂CH₃ or OCOOCH₂CH₂CH₂CH₂CH₂CH₂CH₃, each represents a separate embodiment of this invention. In other embodiments, OCOOR⁶ is OCOO((C₁-C₁₀)haloalkyl). In other embodiments, OCOO((C₁-C₁₀)haloalkyl) is OCOOCF₃, OCOOCF₂CF₃, OCOOCH₂I, OCOOCH₂Br, OCOOCH₂CH₂Br, OCOOCHBrCH₃, OCOOCH₂CH₂CH₂Br, OCOOCH₂CHBrCH₃ or OCOOCHBrCH₂CH₃, each represents a separate embodiment of the invention. In other embodiments, OCOOR⁶ is a OCOO((C₃-C₈)cycloalkyl). In other embodiments, OCOO((C₃-C₅)cycloalkyl) is OCOO(cyclobutyl), OCOO(cyclopentyl) or OCOO(cyclohexyl), each represents a separate embodiment of the invention. In another embodiment, OCOOR⁶ is a OCOO(aryl). In other embodiments, OCOO(aryl) is OCOO(phenyl), OCOO(naphtyl) or OCOO(perylenyl), each represents a separate embodiment of the invention. In other embodiments, OCOOR⁶ is a OCOO(heteroaryl). In another embodiment, OCOO(heteroaryl) is OCOO(pyranyl), OCOO(pyrrolyl), OCOO(pyrazinyl), OCOO(pyrimidinyl), OCOO(pyrazolyl), OCOO(pyridinyl), OCOO(furanyl), OCOO(thiophenyl), OCOO(thiazolyl), OCOO(indolyl), OCOO(imidazolyl), OCOO(isoxazolyl), each represents a separate embodiment of the invention.

In other embodiments, R¹, R² and/or R⁵ is CN.

In other embodiments, R¹, R² and/or R⁵ is CON(R⁶)₂. In other embodiment, CON(R⁶)₂ is CON((C₁-C₁₀)alkyl)₂. In other embodiments, CON((C₁-C₁₀)alkyl)₂ is CON(CH₃)₂, CON(CH₂CH₃)₂, CON(CH₂CH₂CH₃)₂, CON(CH(CH₃)₂)₂, CON(CH₂CH₂CH₂CH₃)₂, CON(C(CH₃)₃)₂, CON(CH₂CH₂CH₂CH₂CH₃)₂, CON(CH₂C(CH₃)₃)₂, CON(CH(CH₂CH₃)₂)₂, CON(CH(CH₃) (CH₂CH₂CH₃))₂, CON(CH(CH₃)₂(CH₂CH₃))₂, CON(CH₂CH₂CH(CH₃)₂)₂, CON(CH₂CH₂CH₂CH₂CH₂CH₃)₂ or CON(CH₂CH₂CH₂CH₂CH₂CH₂CH₃)₂, each represents a separate embodiment of this invention.

In other embodiments, CON(R⁶)₂ is CON((C₁-C₁₀)haloalkyl)₂. In other embodiment, CON((C₁-C₁₀)haloalkyl)₂ is CON(CF₃)₂, CON(CF₂CF₃)₂, CON(CH₂I)₂, CON(CH₂Br)₂, CON(CH₂CH₂Br)₂, CON(CHBrCH₃)₂, CON(CH₂CH₂CH₂Br)₂, CON(CH₂CHBrCH₃)₂ or CON(CHBrCH₂CH₃)₂, each represents a separate embodiment of the invention. In other embodiments, CON(R⁶)₂ is a CON((C₃-C₈)cycloalkyl)₂. In other embodiments, CON((C₃-C₈)cycloalkyl)₂ is CON(cyclobutyl)₂, CON(cyclopentyl)₂ or CON(cyclohexyl)₂, each represents a separate embodiment of the invention. In other embodiments, CON(R⁶)₂ is a CON(aryl)₂. In other embodiments, CON(aryl)₂ is CON(phenyl)₂, CON(naphtyl)₂ or CON(perylenyl)₂, each represents a separate embodiment of the invention. In another embodiment, CON(R⁶)₂ is a CON(heteroaryl)₂. In another embodiment, CON(heteroaryl)₂ is CON(pyranyl)₂, CON(pyrrolyl)₂, CON(pyrazinyl)₂, CON(pyrimidinyl)₂, CON(pyrazolyl)₂, CON(pyridinyl)₂, CON(furanyl)₂, CON(thiophenyl)₂, CON(thiazolyl)₂, CON(indolyl)₂, CON(imidazolyl)₂, CON(isoxazolyl)₂, each represents a separate embodiment of the invention.

In another embodiment, R¹, R² and/or R⁵ is SR⁶. In another embodiment, SR⁶ is S((C₁-C₁₀)alkyl). In another embodiment, S((C₁-C₁₀)alkyl) is SCH₃, SCH₂CH₃, SCH₂CH₂CH₃, SCH(CH₃)₂, SCH₂CH₂CH₂CH₃, SC(CH₃)₃, SCH₂CH₂CH₂CH₂CH₃, SCH₂C(CH₃)₃, SCH(CH₂CH₃)₂, SCH(CH₃) (CH₂CH₂CH₃), SCH(CH₃)₂(CH₂CH₃), SCH₂CH₂CH(CH₃)₂, SCH₂CH₂CH₂CH₂CH₂CH₃ or SCH₂CH₂CH₂CH₂CH₂CH₂CH₃, each represents a separate embodiment of this invention. In other embodiments, SR⁶ is S((C₁-C₁₀)haloalkyl). In another embodiment, S((C₁-C₁₀)haloalkyl) is SCF₃, SCF₂CF₃, SCH₂I, SCH₂Br, SCH₂CH₂Br, SCHBrCH₃, SCH₂CH₂CH₂Br, SCH₂CHBrCH₃ or SCHBrCH₂CH₃, each represents a separate embodiment of the invention. In another embodiment, SR⁶ is a S((C₃-C₈)cycloalkyl). In another embodiment, S((C₃-C₈)cycloalkyl) is S(cyclobutyl), S(cyclopentyl) or S(cyclohexyl), each represents a separate embodiment of the invention. In another embodiment, SR⁶ is S(aryl). In another embodiment, S(aryl) is S(phenyl), S(naphtyl) or S(perylenyl), each represents a separate embodiment of the invention. In other embodiments, SR⁶ is a S(heteroaryl). In another embodiment, S(heteroaryl) is S(pyranyl), S(pyrrolyl), S(pyrazinyl), S(pyrimidinyl), S(pyrazolyl), S(pyridinyl), S(furanyl), S(thiophenyl), S(thiazolyl), S(indolyl), S(imidazolyl), S(isoxazolyl), each represents a separate embodiment of the invention.

In another embodiment, R¹, R² and/or R⁵ is SO₂R⁶. In another embodiment, SO₂R⁶ is SO₂((C₁-C₁₀)alkyl). In another embodiment, SO₂((C₁-C₁₀)alkyl) is SO₂CH₃, SO₂CH₂CH₃, SO₂CH₂CH₂CH₃, SO₂CH(CH₃)₂, SO₂CH₂CH₂CH₂CH₃, SO₂C(CH₃)₃, SO₂CH₂CH₂CH₂CH₂CH₃, SO₂CH₂C(CH₃)₃, SO₂CH(CH₂CH₃)₂, SO₂CH(CH₃) (CH₂CH₂CH₃), SO₂CH(CH₃)₂(CH₂CH₃), SO₂CH₂CH₂CH(CH₃)₂, SO₂CH₂CH₂CH₂CH₂CH₂CH₃ or SO₂CH₂CH₂CH₂CH₂CH₂CH₂CH₃, each represents a separate embodiment of this invention. In other embodiments, SO₂R⁶ is SO₂((C₁-C₁₀)haloalkyl). In another embodiment, SO₂((C₁-C₁₀)haloalkyl) is SO₂CF₃, SO₂CF₂CF₃, SO₂CH₂I, SO₂CH₂Br, SO₂CH₂CH₂Br, SO₂CHBrCH₃, SO₂CH₂CH₂CH₂Br, SO₂CH₂CHBrCH₃ or SO₂CHBrCH₂CH₃, each represents a separate embodiment of the invention. In another embodiment, SO₂R⁶ is a SO₂((C₃-C₈)cycloalkyl). In another embodiment, SO₂((C₃-C₈)cycloalkyl) is SO₂(cyclobutyl), SO₂(cyclopentyl) or SO₂(cyclohexyl), each represents a separate embodiment of the invention. In another embodiment, SO₂R⁶ is SO₂(aryl). In another embodiment, SO₂(aryl) is SO₂(phenyl), SO₂(naphtyl) or SO₂(perylenyl), each represents a separate embodiment of the invention. In another embodiment, SO₂R⁶ is a SO₂(heteroaryl). In another embodiment, SO₂(heteroaryl) is SO₂(pyranyl), SO₂(pyrrolyl), SO₂(pyrazinyl), SO₂(pyrimidinyl), SO₂(pyrazolyl), SO₂(pyridinyl), SO₂(furanyl), SO₂(thiophenyl), SO₂(thiazolyl), SO₂(indolyl), SO₂(imidazolyl), SO₂(isoxazolyl), each represents a separate embodiment of the invention.

In another embodiment, R¹, R² and/or R⁵ is SO₂M. In some embodiments, SO₂M is a SO₂(monovalent cation). In another embodiment, SO₂(monovalent cation) includes SO₂(alkali metal cation), SO₂(NH₄⁺), SO₂(quaternary ammonium cation), and SO₂(quaternary phoshphonium cation). In another embodiment, SO₂M is SO₂Li. In another embodiment, SO₂M is SO₂Na. In another embodiment, SO₂M is SO₂K. In another embodiment, SO₂M is SO₂Rb. In another embodiment, SO₂M is SO₂Cs. In another embodiment, non-limiting examples of the SO₂(quarternary ammonium cation), include SO₂(tetrametylammonium), SO₂(tetraethylammonium), SO₂(tetrabutylammonium), SO₂(tetraoctylammonium), SO₂(trimethyloctylammonium) and SO₂(cetyltrimethylammonium), each represents a separate embodiment of the invention. In another embodiment, non-limiting examples of the SO₂(quarternary phosphonium cation), include SO₂(tetraphenylphosphonium), SO₂(dimethyldiphenylphosphonium), SO₂(tetrabutylphosphonium), SO₂(methyltriphenoxyphosphonium) and SO₂(tetramethylphosphonium), each represents a separate embodiment of the invention.

In another embodiment, R¹, R² and/or R⁵ is SOR⁶. In another embodiment, SOR⁶ is SO((C₁-C₁₀)alkyl). In another embodiment, SO((C₁-C₁₀)alkyl) is SOCH₃, SOCH₂CH₃, SOCH₂CH₂CH₃, SOCH(CH₃)₂, SOCH₂CH₂CH₂CH₃, SOC(CH₃)₃, SOCH₂CH₂CH₂CH₂CH₃, SOCH₂C(CH₃)₃, SOCH(CH₂CH₃)₂, SOCH(CH₃)(CH₂CH₂CH₃), SOCH(CH₃)₂(CH₂CH₃) SOCH₂CH₂CH(CH₃)₂, SOCH₂CH₂CH₂CH₂CH₂CH₃ or SOCH₂CH₂CH₂CH₂CH₂CH₂CH₃, each represents a separate embodiment of this invention. In other embodiments, SOR⁶ is SO((C₁-C₁₀)haloalkyl). In another embodiment, SO((C₁-C₁₀)haloalkyl) is SOCF₃, SOCF₂CF₃, SOCH₂I, SOCH₂Br, SOCH₂CH₂Br, SOCHBrCH₃, SOCH₂CH₂CH₂Br, SOCH₂CHBrCH₃ or SOCHBrCH₂CH₃, each represents a separate embodiment of the invention. In another embodiment, SOR⁶ is a SO((C₃-C₈)cycloalkyl). In another embodiment, SO((C₃-C₈)cycloalkyl) is SO(cyclobutyl), SO(cyclopentyl) or SO(cyclohexyl), each represents a separate embodiment of the invention. In another embodiment, SOR⁶ is SO(aryl). In another embodiment, SO(aryl) is SO(phenyl), SO(naphtyl) or SO(perylenyl), each represents a separate embodiment of the invention. In another embodiment, SOR⁶ is a SO(heteroaryl). In another embodiment, SO(heteroaryl) is SO(pyranyl), SO(pyrrolyl), SO(pyrazinyl), SO(pyrimidinyl), SO(pyrazolyl), SO(pyridinyl), SO(furanyl), SO(thiophenyl), SO(thiazolyl), SO(indolyl), SO(imidazolyl), SO(isoxazolyl), each represents a separate embodiment of the invention.

In another embodiment, R¹, R² and/or R⁵ is SO₃H.

In another embodiment, R¹, R² and/or R⁵ is SO₃M. In some embodiments, SO₃M is a SO₃(monovalent cation). In another embodiment, SO₃(monovalent cation) includes SO₃(alkali metal cation), SO₃(NH₄⁺), SO₃(quaternary ammonium cation), and SO₃(quaternary phoshphonium cation). In another embodiment, SO₃M is SO₃Li. In another embodiment, SO₃M is SO₃Na. In another embodiment, SO₃M is SO₃K. In another embodiment, SO₃M is SO₃Rb. In another embodiment, SO₃M is SO₃Cs. In another embodiment, non-limiting examples of the SO₃(quarternary ammonium cation), include SO₃(tetrametylammonium), SO₃(tetraethylammonium), SO₃(tetrabutylammonium), SO₃(tetraoctylammonium), SO₃(trimethyloctylammonium) and SO₃(cetyltrimethylammonium), each represents a separate embodiment of the invention. In another embodiment, non-limiting examples of the SO₃(quarternary phosphonium cation), include SO₃(tetraphenylphosphonium), SO₃(dimethyldiphenylphosphonium), SO₃(tetrabutylphosphonium), SO₃(methyltriphenoxyphosphonium) and SO₃(tetramethylphosphonium), each represents a separate embodiment of the invention.

In another embodiment, R¹, R² and/or R⁵ is SO₂NH₂. In another embodiment, R¹ and/or R⁵ is SO₂NH(R⁶). In another embodiment, SO₂NHR₆ is SO₂NH((C₁-C₁₀)alkyl). In another embodiment, SO₂NH((C₁-C₁₀)alkyl) is SO₂NHCH₃, SO₂NHCH₂CH₃, SO₂NHCH₂CH₂CH₃, SO₂NHCH(CH₃)₂, SO₂NHCH₂CH₂CH₂CH₃, SO₂NHC(CH₃)₃, SO₂NHCH₂CH₂CH₂CH₂CH₃, SO₂NHCH₂C(CH₃)₃, SO₂NHCH(CH₂CH₃)₂, SO₂NHCH(CH₃) (CH₂CH₂CH₃), SO₂NH CH(CH₃)₂(CH₂CH₃), SO₂NHCH₂CH₂CH(CH₃)₂, SO₂NHCH₂CH₂CH₂CH₂CH₂CH₃ or SO₂NH CH₂CH₂CH₂CH₂CH₂CH₂CH₃, each represents a separate embodiment of this invention. In other embodiments, SO₂NHR₆ is SO₂NH((C₁-C₁₀)haloalkyl). In another embodiment, SO₂NH((C₁-C₁₀)haloalkyl) is SO₂NHCF₃, SO₂NHCF₂CF₃, SO₂NHCH₂I, SO₂NHCH₂Br, SO₂NHCH₂CH₂Br, SO₂NHCHBrCH₃, SO₂NHCH₂CH₂CH₂Br, SO₂NHCH₂CHBrCH₃ or SO₂NHCHBrCH₂CH₃, each represents a separate embodiment of the invention. In another embodiment, SO₂NHR₆ is a SO₂NH((C₃-C₈)cycloalkyl). In another is embodiment, SO₂NH((C₃-C₈)cycloalkyl) SO₂NH(cyclobutyl), SO₂NH(cyclopentyl) or SO₂NH(cyclohexyl), each represents a separate embodiment of the invention. In another embodiment, SO₂NHR₆ is a SO₂NH(aryl). In another embodiment, SO₂NH(aryl) is SO₂NH(phenyl), SO₂NH(naphtyl) or SO₂NH(perylenyl), each represents a separate embodiment of the invention. In another embodiment, SO₂NHR₆ is a SO₂NH(heteroaryl). In another embodiment, SO₂NH(heteroaryl) is SO₂NH(pyranyl), SO₂NH(pyrrolyl), SO₂NH(pyrazinyl), SO₂NH(pyrimidinyl), SO₂NH(pyrazolyl), SO₂NH(pyridinyl), SO₂NH(furanyl), SO₂NH(thiophenyl), SO₂NH(thiazolyl), SO₂NH(indolyl), SO₂NH(imidazolyl), SO₂NH(isoxazolyl), each represents a separate embodiment of the invention.

In another embodiment, R¹, R² and/or R⁵ is SO₂N(R⁶)₂. In another embodiment, SO₂N(R⁶)₂ is SO₂N((C₁-C₁₀)alkyl)₂. In another embodiment, SO₂N((C₁-C₁₀)alkyl)₂ is SO₂N(CH₃)₂, SO₂N(CH₂CH₃)₂, SO₂N(CH₂CH₂CH₃)₂, SO₂N(CH(CH₃)₂)₂, SO₂N(CH₂CH₂CH₂CH₃)₂, SO₂N(C(CH₃)₃)₂, SO₂N(CH₂CH₂CH₂CH₂CH₃)₂, SO₂N(CH₂C(CH₃)₃)₂, SO₂N(CH(CH₂CH₃)₂)₂, SO₂N(CH(CH₃) (CH₂CH₂CH₃))₂, SO₂N(CH(CH₃)₂(CH₂CH₃))₂, SO₂N(CH₂CH₂CH(CH₃)₂)₂, SO₂N(CH₂CH₂CH₂CH₂CH₂CH₃)₂ or SO₂N(CH₂CH₂CH₂CH₂CH₂CH₂CH₃)₂, each represents a separate embodiment of this invention. In other embodiments, SO₂N(R⁶)₂ is SO₂N((C₁-C₁₀)haloalkyl)₂. In another embodiment, SO₂N((C₁-C₁₀)haloalkyl)₂ is SO₂N(CF₃)₂, SO₂N(CF₂CF₃)₂, SO₂N(CH₂I)₂, SO₂N(CH₂Br)₂, SO₂N(CH₂CH₂Br)₂, SO₂N(CHBrCH₃)₂, SO₂N(CH₂CH₂CH₂Br)₂, SO₂N(CH₂CHBrCH₃)₂ or SO₂N(CHBrCH₂CH₃)₂, each represents a separate embodiment of the invention. In another embodiment, SO₂N(R⁶)₂ is a SO₂N((C₃-C₈)cycloalkyl)₂. In another embodiment, SO₂N((C₃-C₈)cycloalkyl)₂ is SO₂N(cyclobutyl)₂, SO₂N(cyclopentyl)₂ or SO₂N(cyclohexyl)₂, each represents a separate embodiment of the invention. In another embodiment, SO₂N(R⁶)₂ is a SO₂N(aryl)₂. In another embodiment, SO₂N(aryl)₂ is SO₂N(phenyl)₂, SO₂N (naphtyl)₂ or SO₂N (perylenyl)₂, each represents a separate embodiment of the invention. In another embodiment, SO₂N(R⁶)₂ is a SO₂N(heteroaryl)₂. In another embodiment, SO₂N(heteroaryl)₂ is SO₂N(pyranyl)₂, SO₂N(pyrrolyl)₂, SO₂N(pyrazinyl)₂, SO₂N(pyrimidinyl)₂, SO₂N(pyrazolyl)₂, SO₂N(pyridinyl)₂, SO₂N(furanyl)₂, SO₂N(thiophenyl)₂, SO₂N (thiazolyl)₂, SO₂N(indolyl)₂, SO₂N(imidazolyl)₂, SO₂N(isoxazolyl)₂, each represents a separate embodiment of the invention.

In another embodiment, R¹, R² and/or R⁵ is NH₂.

In another embodiment, R¹, R² and/or R⁵ is NH(R⁶). In another embodiment, NHR₆ is NH((C₁-C₁₀)alkyl). In another embodiment, NH((C₁-C₁₀)alkyl) is NHCH₃, NHCH₂CH₃, NHCH₂CH₂CH₃, NHCH(CH₃)₂, NHCH₂CH₂CH₂CH₃, NHC(CH₃)₃, NHCH₂CH₂CH₂CH₂CH₃, NHCH₂C(CH₃)₃, NHCH(CH₂CH₃)₂, NHCH(CH₃) (CH₂CH₂CH₃), NHCH(CH₃)₂(CH₂CH₃), NHCH₂CH₂CH(CH₃)₂, NHCH₂CH₂CH₂CH₂CH₂CH₃ or NHCH₂CH₂CH₂CH₂CH₂CH₂CH₃, each represents a separate embodiment of this invention. In other embodiments, NHR₆ is NH((C₁-C₁₀)haloalkyl). In another embodiment, NH((C₁-C₁₀)haloalkyl) is NHCF₃, NHCF₂CF₃, NHCH₂I, NHCH₂Br, NHCH₂CH₂Br, NHCHBrCH₃, NHCH₂CH₂CH₂Br, NHCH₂CHBrCH₃ or NHCHBrCH₂CH₃, each represents a separate embodiment of the invention. In another embodiment, NHR₆ is a NH((C₃-C₈)cycloalkyl). In another embodiment, NH((C₃-C₈)cycloalkyl) is NH(cyclobutyl), NH(cyclopentyl) or NH(cyclohexyl), each represents a separate embodiment of the invention. In another embodiment, NHR₆ is a NH(aryl). In another embodiment, NH(aryl) is NH(phenyl), NH(naphtyl) or NH(perylenyl), each represents a separate embodiment of the invention. In another embodiment, NHR₆ is a NH(heteroaryl). In another embodiment, NH(heteroaryl) is NH(pyranyl), NH(pyrrolyl), NH(pyrazinyl), NH(pyrimidinyl), NH(pyrazolyl), NH(pyridinyl), NH(furanyl), NH(thiophenyl), NH(thiazolyl), NH(indolyl), NH(imidazolyl), NH(isoxazolyl), each represents a separate embodiment of the invention.

In another embodiment, R¹, R² and/or R⁵ is N(R⁶)₂. In another embodiment, N(R⁶) 2 is N((C₁-C₁₀)alkyl)₂. In another embodiment, N((C₁-C₁₀)alkyl)₂ is N(CH₃)₂, N(CH₂CH₃)₂, N(CH₂CH₂CH₃)₂, N(CH(CH₃)₂)₂, N(CH₂CH₂CH₂CH₃)₂, N(C(CH₃)₃)₂, N(CH₂CH₂CH₂CH₂CH₃)₂, N(CH₂C(CH₃)₃)₂, N(CH(CH₂CH₃)₂)₂, N(CH(CH₃) (CH₂CH₂CH₃))₂N(CH(CH₃)₂(CH₂CH₃))₂, N(CH₂CH₂CH(CH₃)₂)₂, N(CH₂CH₂CH₂CH₂CH₂CH₃)₂ or N(CH₂CH₂CH₂CH₂CH₂CH₂CH₃)₂, each represents a separate embodiment of this invention. In other embodiments, N(R⁶)₂ is N((C₁-C₁₀)haloalkyl)₂. In another embodiment, N((C₁-C₁₀)haloalkyl)₂ is N(CF₃)₂, N(CF₂CF₃)₂, N(CH₂I)₂, N(CH₂Br)₂, N(CH₂CH₂Br)₂, N(CHBrCH₃)₂, N(CH₂CH₂CH₂Br)₂, N(CH₂CHBrCH₃)₂ or N(CHBrCH₂CH₃)₂, each represents a separate embodiment of the invention. In another embodiment, N(R⁶)₂ is a N((C₃-C₈)cycloalkyl)₂. In another embodiment, N((C₃-C₈)cycloalkyl) 2 is N(cyclobutyl)₂, N(cyclopentyl)₂ or N(cyclohexyl)₂, each represents a separate embodiment of the invention. In another embodiment, N(R⁶)₂ is a N(aryl)₂. In another embodiment, N(aryl)₂ is N(phenyl)₂, N (naphtyl)₂ or N (perylenyl)₂, each represents a separate embodiment of the invention. In another embodiment, N(R⁶)₂ is a CON(heteroaryl)₂. In another embodiment, N(heteroaryl)₂ is N(pyranyl)₂, N(pyrrolyl)₂, N(pyrazinyl)₂, N(pyrimidinyl)₂, N(pyrazolyl)₂, N(pyridinyl)₂, N(furanyl)₂, N(thiophenyl)₂, N (thiazolyl)₂, N(indolyl)₂, N (imidazolyl)₂, N(isoxazolyl)₂, each represents a separate embodiment of the invention.

In another embodiment, R¹, R² and/or R⁵ is CONH₂.

In another embodiment, R¹, R² and/or R⁵ is CONH(R⁶). In another embodiment, CONHR⁶ is CONH((C₁-C₁₀)alkyl). In another embodiment, CONH((C₁-C₁₀)alkyl) is CONHCH₃, CONHCH₂CH₃, CONHCH₂CH₂CH₃, CONHCH(CH₃)₂, CONHCH₂CH₂CH₂CH₃, CONHC(CH₃)₃, CONHCH₂CH₂CH₂CH₂CH₃, CONHCH₂C(CH₃)₃, CONHCH(CH₂CH₃)₂, CONHCH(CH₃) (CH₂CH₂CH₃), CONHCH(CH₃)₂(CH₂CH₃), CONHCH₂CH₂CH(CH₃)₂, CONHCH₂CH₂CH₂CH₂CH₂CH₃ or CONHCH₂CH₂CH₂CH₂CH₂CH₂CH₃, each represents a separate embodiment of this invention. In other embodiments, CONHR⁶ is CONH((C₁-C₁₀)haloalkyl). In another embodiment, CONH((C₁-C₁₀)haloalkyl) is CONHCF₃, CONHCF₂CF₃, CONHCH₂I, CONHCH₂Br, CONHCH₂CH₂Br, CONHCHBrCH₃, CONHCH₂CH₂CH₂Br, CONHCH₂CHBrCH₃ or CONHCHBrCH₂CH₃, each represents a separate embodiment of the invention. In another embodiment, CONHR⁶ is a CONH((C₃-C₈)cycloalkyl). In another embodiment, CONH((C₃-C₈)cycloalkyl) is CONH(cyclobutyl), CONH(cyclopentyl) or CONH (cyclohexyl), each represents a separate embodiment of the invention. In another embodiment, CONHR⁶ is a CONH(aryl). In another embodiment, CONH(aryl) is CONH(phenyl), CONH(naphtyl) or CONH(perylenyl), each represents a separate embodiment of the invention. In another embodiment, CONHR⁶ is a CONH(heteroaryl). In another embodiment, CONH(heteroaryl) is CONH(pyranyl), CONH(pyrrolyl), CONH(pyrazinyl), CONH(pyrimidinyl), CONH(pyrazolyl), CONH(pyridinyl), CONH(furanyl), CONH(thiophenyl), CONH(thiazolyl), CONH(indolyl), CONH(imidazolyl), CONH(isoxazolyl), each represents a separate embodiment of the invention.

In another embodiment, R¹, R² and/or R⁵ is CO(N-heterocycle). In another embodiment, CO(N-heterocycle) CO(pyridine), CO(piperidine), CO(morpholine), CO(piperazine), CO(pyrrolidine), CO(pyrrole), CO(imidazole), CO(pyrazole), CO(pyrazolidine), CO(triazole), CO(tetrazole), CO(piperazine), CO(diazine), or CO(triazine), each represents a separate embodiment of the invention.

In another embodiment, R¹, R² and/or R⁵ is NO₂. In another embodiment, R¹, R² and/or R⁵ is CN. In another embodiment, R¹, R² and/or R⁵ is cyanate. In another embodiment, R¹, R² and/or R⁵ is isocyanate. In another embodiment, R¹, R² and/or R⁵ is thiocyanate. In another embodiment, R¹, R² and/or R⁵ is isothiocyanate. In another embodiment, R¹, R² and/or R⁵ is mesylate. In another embodiment, R¹, R² and/or R⁵ is triflate. In another embodiment, R¹, R² and/or R⁵ is tosylate. In another embodiment, R¹, R² and/or R⁵ is PO(OH)₂. In another embodiment, R¹, R² and/or R⁵ is OPO(OH)₂.

In other embodiments, the perylene diimide derivative is represented by the structure of 1, 2, 3, 4a, 4b or 5:

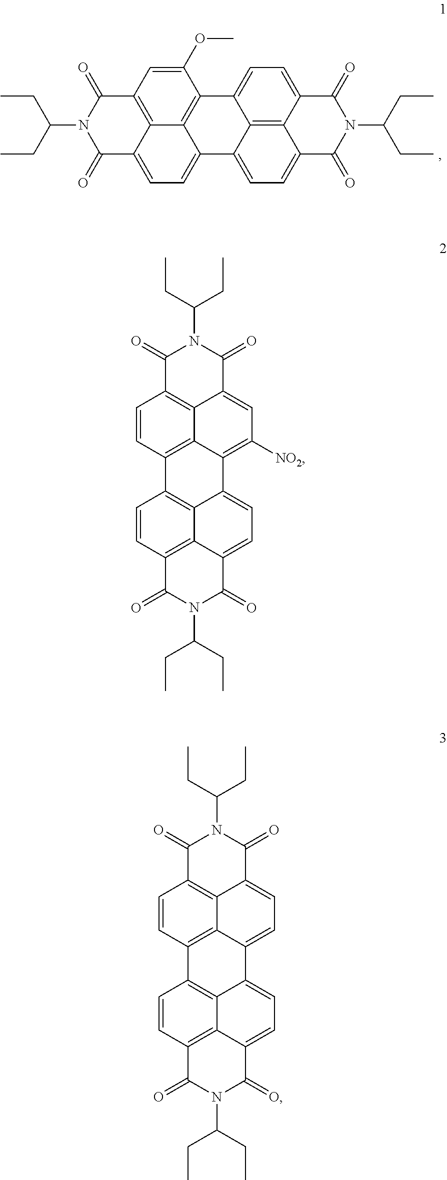 [SMILES: CCC(CC)N1C(=O)c2ccc3c4ccc5c6c(cc(OC)c(c7ccc(c2c37)C1=O)c64)C(=O)N(C(CC)CC)C5=O ; CCC(CC)N1C(=O)c2ccc3c4ccc5c6c(cc([N+](=O)[O-])c(c7ccc(c2c37)C1=O)c64)C(=O)N(C(CC)CC)C5=O ; CCC(CC)N1C(=O)c2ccc3c4ccc5c6c(ccc(c7ccc(c2c37)C1=O)c64)C(=O)N(C(CC)CC)C5=O]

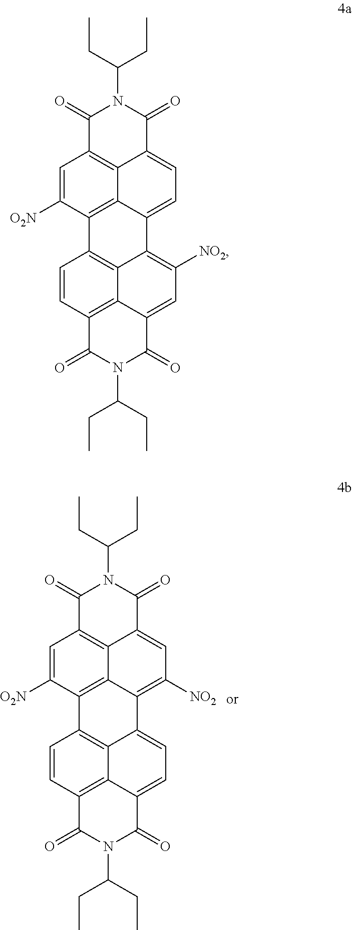

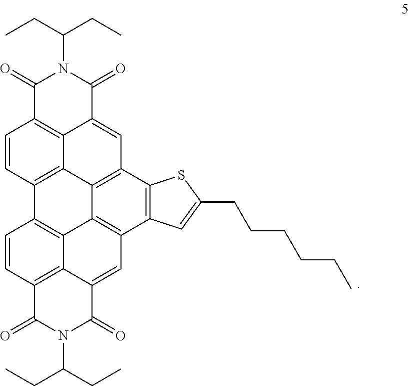 [SMILES: CCCCCCc1cc2c3cc4c(=O)n(C(CC)CC)c(=O)c5ccc6c7ccc8c(=O)n(C(CC)CC)c(=O)c9cc(c2s1)c(c7c89)c3c6c54]

### Anthraquinone Derivatives

In another embodiment, the anthraquinone and derivative thereof is represented by the structure of formula IV:

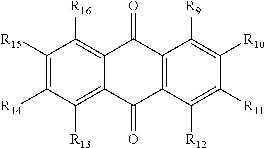

wherein each of R₉-R₁₆ is independently hydrogen, hydroxy, alkyl, alkenyl, halide, haloalkyl, CN, COOH, alkyl-COOH, alkylamine, amide, alkylamide, aryl, heteroaryl, cycloalkyl, heterocycloalkyl, thio (SH), thioalkyl, alkoxy, ether (alkyl-O-alkyl), OR¹⁷, COR¹⁷, COOCOR¹⁷, COOR¹⁷, OCOR¹⁷, OCONHR¹⁷, NHCOOR¹⁷, NHCONHR¹⁷, OCOOR¹⁷, CON(R¹⁷)₂, SR¹⁷, SO₂R¹⁷, SOR¹⁷, SO₂NH₂, SO₂NH(R¹⁷), SO₂N(R¹⁷)₂, NH₂, NH(R¹⁷), N(R¹⁷)₂, CONH₂, CONH(R¹⁷), CON(R¹⁷)₂, CO(N-heterocycle), NO₂, cyanate, isocyanate, thiocyanate, isothiocyanate, mesylate, tosylate or triflate; wherein R⁹ is H, (C₁-C₁₀)alkyl, (C₁-C₁₀)haloalkyl, (C₃-C₈)cycloalkyl, aryl or heteroaryl, wherein the alkyl, haloalkyl, cycloalkyl, aryl or heteroaryl groups are optionally substituted. Each represents a separate embodiment of this invention. In other embodiments, the carbon nanotube is a single-walled carbon nanotube.

In other embodiments, the carbon nanotube is a multi-walled carbon nanotube. In some embodiments, R₉, R₁₀, R₁₁, R₁₂, R₁₃, R₁₄, R₁₅ or R₁₆ is each independently a hydrogen. In some embodiments, R₉, R₁₀, R₁₁, R₁₂, R₁₃, R₁₄, R₁₅ or R₁₆ is each independently hydroxy. In some embodiments, R₉, R₁₀, R₁₁, R₁₂, R₁₃, R₁₄, R₁₅ or R₁₆ is each independently an alkyl. In some embodiments, R₉, R₁₀, R₁₁, R₁₂, R₁₃, R₁₄, R₁₅ or R₁₆ is each independently an alkenyl. In some embodiments, R₉, R₁₀, R₁₁, R₁₂, R₁₃, R₁₄, R₁₅ or R₁₆ is each independently a halide. In some embodiments, R₉, R₁₀, R₁₁, R₁₂, R₁₃, R₁₄, R₁₅ or R₁₆ is each independently a haloalkyl. In some embodiments, R₉, R₁₀, R₁₁, R₁₂, R₁₃, R₁₄, R₁₅ or R₁₆ is each independently a CN. In some embodiments, R₉, R₁₀, R₁₁, R₁₂, R₁₃, R₁₄, R₁₅ or R₁₆ is each independently a COOH. In some embodiments, R₉, R₁₀, R₁₁, R₁₂, R₁₃, R₁₄, R₁₅ or R₁₆ is each independently a alkyl-COOH. In some embodiments, R₉, R₁₀, R₁₁, R₁₂, R₁₃, R₁₄, R₁₅ or R₁₆ is each independently an alkylamine. In some embodiments, R₉, R₁₀, R₁₁, R₁₂, R₁₃, R₁₄, R₁₅ or R₁₆ is each independently an amide. In some embodiments R₉, R₁₀, R₁₁, R₁₂, R₁₃, R₁₄, R₁₅ or R₁₆ is each independently an aryl. In some embodiments, R₉, R₁₀, R₁₁, R₁₂, R₁₃, R₁₄, R₁₅ or R₁₆ is each independently a heteroaryl. In some embodiments, R₉, R₁₀, R₁₁, R₁₂, R₁₃, R₁₄, R₁₅ or R₁₆ are each independently a cycloalkyl. In some embodiments, R₉, R₁₀, R₁₁, R₁₂, R₁₃, R₁₄, R₁₅ or R₁₆ is each independently a heterocycloalkyl. In some embodiments, R₉, R₁₀, R₁₁, R₁₂, R₁₃, R₁₄, R₁₅ or R₁₆ is each independently a haloalkyl. In some embodiments, R₉, R₁₀, R₁₁, R₁₂, R₁₃, R₁₄, R₁₅ or R₁₆ is each independently a thio (SH). In some embodiments, R₉, R₁₀, R₁₁, R₁₂, R₁₃, R₁₄, R₁₅ or R₁₆ is each independently a thioalkyl. In some embodiments, R₉, R₁₀, R₁₁, R₁₂, R₁₃, R₁₄, R₁₅ or R₁₆ is each independently an alkoxy. In some embodiments, R₉, R₁₀, R₁₁, R₁₂, R₁₃, R₁₄, R₁₅ or R₁₆ is each independently an ether (alkyl-O-alkyl). In some embodiments, R₉, R₁₀, R₁₁, R₁₂, R₁₃, R₁₄, R₁₅ or R₁₆ is each independently a OR¹⁷, wherein R₁₇ is H, (C₁-C₁₀)alkyl, (C₁-C₁₀)haloalkyl, (C₃-C₈)cycloalkyl, aryl or heteroaryl, wherein the alkyl, haloalkyl, cycloalkyl, aryl or heteroaryl groups are optionally substituted. In some embodiments, R₉, R₁₀, R₁₁, R₁₂, R₁₃, R₁₄, R₁₅ or R₁₆ are each independently a COR¹⁷, wherein R₁₇ is H, (C₁-C₁₀)alkyl, (C₁-C₁₀)haloalkyl, (C₃-C₈)cycloalkyl, aryl or heteroaryl, wherein the alkyl, haloalkyl, cycloalkyl, aryl or heteroaryl groups are optionally substituted. In some embodiments, R₉, R₁₀, R₁₁, R₁₂, R₁₃, R₁₄, R₁₅ or R₁₆ are each independently a COOCOR¹⁷, wherein R₁₇ is H, (C₁-C₁₀)alkyl, (C₁-C₁₀)haloalkyl, (C₃-C₈)cycloalkyl, aryl or heteroaryl, wherein the alkyl, haloalkyl, cycloalkyl, aryl or heteroaryl groups are optionally substituted. In some embodiments, R₉, R₁₀, R₁₁, R₁₂, R₁₃, R₁₄, R₁₅ or R₁₆ are each independently a COOR¹⁷, wherein R₁₇ is H, (C₁-C₁₀)alkyl, (C₁-C₁₀)haloalkyl, (C₃-C₈)cycloalkyl, aryl or heteroaryl, wherein the alkyl, haloalkyl, cycloalkyl, aryl or heteroaryl groups are optionally substituted. In some embodiments, R₉, R₁₀, R₁₁, R₁₂, R₁₃, R₁₄, R₁₅ or R₁₆ is each independently a OCOR¹⁷, wherein R¹⁷ is H, (C₁-C₁₀)alkyl, (C₁-C₁₀)haloalkyl, (C₃-C₈)cycloalkyl, aryl or heteroaryl, wherein the alkyl, haloalkyl, cycloalkyl, aryl or heteroaryl groups are optionally substituted. In some embodiments, R₉, R₁₀, R₁₁, R₁₂, R₁₃, R₁₄, R₁₅ or R₁₆ is each independently a OCONHR¹⁷, wherein R¹⁷ is H, (C₁-C₁₀)alkyl, (C₁-C₁₀)haloalkyl, (C₃-C₈)cycloalkyl, aryl or heteroaryl, wherein the alkyl, haloalkyl, cycloalkyl, aryl or heteroaryl groups are optionally substituted. In some embodiments, R₉, R₁₀, R₁₁, R₁₂, R₁₃, R₁₄, R₁₅ or R₁₆ is each independently a NHCOOR¹⁷, wherein R¹⁷ is H, (C₁-C₁₀)alkyl, (C₁-C₁₀)haloalkyl, (C₃-C₈)cycloalkyl, aryl or heteroaryl, wherein the alkyl, haloalkyl, cycloalkyl, aryl or heteroaryl groups are optionally substituted. In some embodiments, R₉, R₁₀, R₁₁, R₁₂, R₁₃, R₁₄, R₁₅ or R₁₆ is each independently a NHCONHR¹⁷, wherein R¹⁷ is H, (C₁-C₁₀)alkyl, (C₁-C₁₀)haloalkyl, (C₃-C₈)cycloalkyl, aryl or heteroaryl, wherein the alkyl, haloalkyl, cycloalkyl, aryl or heteroaryl groups are optionally substituted. In some embodiments, R₉, R₁₀, R₁₁, R₁₂, R₁₃, R₁₄, R₁₅ or R₁₆ is each independently a OCOOR¹⁷, wherein R¹⁷ is H, (C₁-C₁₀)alkyl, (C₁-C₁₀)haloalkyl, (C₃-C₈)cycloalkyl, aryl or heteroaryl, wherein the alkyl, haloalkyl, cycloalkyl, aryl or heteroaryl groups are optionally substituted. In some embodiments, R₉, R₁₀, R₁₁, R₁₂, R₁₃, R₁₄, R₁₅ or R₁₆ is each independently a CON(R¹⁷)₂, wherein R¹⁷ is H, (C₁-C₁₀)alkyl, (C₁-C₁₀)haloalkyl, (C₃-C₈)cycloalkyl, aryl or heteroaryl, wherein the alkyl, haloalkyl, cycloalkyl, aryl or heteroaryl groups are optionally substituted. In some embodiments, R₉, R₁₀, R₁₁, R₁₂, R₁₃, R₁₄, R₁₅ or R₁₆ is each independently a SR¹⁷, wherein R¹⁷ is H, (C₁-C₁₀)alkyl, (C₁-C₁₀)haloalkyl, (C₃-C₈)cycloalkyl, aryl or heteroaryl, wherein the alkyl, haloalkyl, cycloalkyl, aryl or heteroaryl groups are optionally substituted. In some embodiments, R₉, R₁₀, R₁₁, R₁₂, R₁₃, R₁₄, R₁₅ or R₁₆ is each independently a SO₂R¹⁷, wherein R¹⁷ is H, (C₁-C₁₀)alkyl, (C₁-C₁₀)haloalkyl, (C₃-C₈)cycloalkyl, aryl or heteroaryl, wherein the alkyl, haloalkyl, cycloalkyl, aryl or heteroaryl groups are optionally substituted. In some embodiments, R₉, R₁₀, R₁₁, R₁₂, R₁₃, R₁₄, R₁₅ or R₁₆ is each independently a SOR¹⁷, wherein R¹⁷ is H, (C₁-C₁₀)alkyl, (C₁-C₁₀)haloalkyl, (C₃-C₈)cycloalkyl, aryl or heteroaryl, wherein the alkyl, haloalkyl, cycloalkyl, aryl or heteroaryl groups are optionally substituted. In some embodiments, R⁹, R¹⁰, R¹¹, R¹², R₁₃, R₁₄, R₁₅ or R₁₆ is each independently a SO₂NH₂. In some embodiments, R₉, R₁₀, R₁₁, R₁₂, R₁₃, R₁₄, R₁₅ or R₁₆ are each independently a SO₂NH(R¹⁷), wherein R¹⁷ is H, (C₁-C₁₀)alkyl, (C₁-C₁₀)haloalkyl, (C₃-C₈)cycloalkyl, aryl or heteroaryl, wherein the alkyl, haloalkyl, cycloalkyl, aryl or heteroaryl groups are optionally substituted. In some embodiments, R₉, R₁₀, R₁₁, R₁₂, R₁₃, R₁₄, R₁₅ or R₁₆ is each independently a SO₂N(R¹⁷)₂, wherein R¹⁷ is H, (C₁-C₁₀)alkyl, (C₁-C₁₀)haloalkyl, (C₃-C₈)cycloalkyl, aryl or heteroaryl, wherein the alkyl, haloalkyl, cycloalkyl, aryl or heteroaryl groups are optionally substituted. In some embodiments, R₉, R₁₀, R₁₁, R₁₂, R₁₃, R₁₄, R₁₅ or R₁₆ is each independently a NH₂. In some embodiments, R₉, R₁₀, R₁₁, R₁₂, R₁₃, R₁₄, R₁₅ or R₁₆ are each independently a NH(R¹⁷), wherein R¹⁷ is H, (C₁-C₁₀)alkyl, (C₁-C₁₀)haloalkyl, (C₃-C₈)cycloalkyl, aryl or heteroaryl, wherein the alkyl, haloalkyl, cycloalkyl, aryl or heteroaryl groups are optionally substituted. In some embodiments, R₉, R₁₀, R₁₁, R₁₂, R₁₃, R₁₄, R₁₅ or R₁₆ are each independently a N(R¹⁷)₂, wherein R¹⁷ is H, (C₁-C₁₀)alkyl, (C₁-C₁₀)haloalkyl, (C₃-C₅)cycloalkyl, aryl or heteroaryl, wherein the alkyl, haloalkyl, cycloalkyl, aryl or heteroaryl groups are optionally substituted. In some embodiments, R₉, R₁₀, R₁₁, R₁₂, R₁₃, R₁₄, R₁₅ or R₁₆ is each independently a CONH₂. In some embodiments, R₉, R₁₀, R₁₁, R₁₂, R₁₃, R₁₄, R₁₅ or R₁₆ is each independently a haloalkyl CONH(R¹⁷). In some embodiments, R₉, R₁₀, R₁₁, R₁₂, R₁₃, R₁₄, R₁₅ or R₁₆ is each independently a CON(R¹⁷)₂. In some embodiments, R₉, R₁₀, R₁₁, R₁₂, R₁₃, R₁₄, R₁₅ or R₁₆ is each independently a CO(N-heterocycle. In some embodiments, R₉, R₁₀, R₁₁, R₁₂, R₁₃, R₁₄, R₁₅ or R₁₆ is each independently a NO₂. In some embodiments, R₉, R₁₀, R₁₁, R₁₂, R₁₃, R₁₄, R₁₅ or R₁₆ is each independently a cyanate. In some embodiments, R₉, R₁₀, R₁₁, R₁₂, R₁₃, R₁₄, R₁₅ or R₁₆ is each independently an isocyanate. In some embodiments, R₉, R₁₀, R₁₁, R₁₂, R₁₃, R₁₄, R₁₅ or R₁₆ is each independently a thiocyanate. In some embodiments, R₉, R₁₀, R₁₁, R₁₂, R₁₃, R₁₄, R₁₅ or R₁₆ is each independently an isothiocyanate. In some embodiments, R₉, R₁₀, R₁₁, R₁₂, R₁₃, R₁₄, R₁₅ or R₁₆ is each independently a mesylate. In some embodiments, R₉, R₁₀, R₁₁, R₁₂, R₁₃, R₁₄, R₁₅ or R₁₆ is each independently a tosylate. In some embodiments, R₉, R₁₀, R₁₁, R₁₂, R₁₃, R₁₄, R₁₅ or R₁₆ is each independently a triflate. In some embodiments, R₉, R₁₀, R₁₁, R₁₂, R₁₃, R₁₄, R₁₅ or R₁₆ is not SO₂H.

### General Definitions for the Aromatic Compounds

The term “alkyl” group refers to a saturated aliphatic hydrocarbon, including straight-chain or branched-chain. In one embodiment, alkyl group is linear or branched. In another embodiment, alkyl is optionally substituted linear or branched. In one embodiment, the alkyl group has between 1-20 carbons. In one embodiment, the alkyl group has between 1-10 carbons. In one embodiment, the alkyl group has between 2-10 carbons. In one embodiment, the alkyl group has between 1-6 carbons. In one embodiment, the alkyl group has between 2-8 carbons. In one embodiment, the alkyl group has 1-12 carbons. In another embodiment, the alkyl group has 1-7 carbons. In another embodiment, the alkyl group has 1-6 carbons. In another embodiment, the alkyl group has 6-12 carbons. In another embodiment, the alkyl group has 8-12 carbons. In another embodiment, the alkyl group has 1~4 carbons. In another embodiment, non-limiting examples of alkyl groups include methyl, ethyl, propyl, isopropyl, isobutyl, butyl, pentyl, 3-pentyl, hexyl heptyl, octyl and hexadecyl. In another embodiment, the alkyl group is optionally substituted by one or more halogens, hydroxides, alkoxy carbonyl, amido, alkylamido, dialkylamido, amino, alkylamino, dialkylamino, carboxyl, thio, thioalkyl, alkoxides, carboxylic acids, phosphates, phosphonates, sulfates, sulfonates amidates, cyanates, and a nitro group. Each possibility represents a separate embodiment of the invention.

An “alkenyl” group refers, in another embodiment, to an unsaturated hydrocarbon, including straight chain, branched chain and cyclic groups having one or more double bond. The alkenyl group may have one double bond, two double bonds, three double bonds etc. Examples of alkenyl groups are ethenyl, propenyl, butenyl, cyclohexenyl etc. The alkenyl group may be unsubstituted or substituted by one or more groups selected from halogen, hydroxy, alkoxy carbonyl, amido, alkylamido, dialkylamido, nitro, amino, alkylamino, dialkylamino, carboxyl, thio and thioalkyl.

The term “cycloalkyl” group refers to a ring structure comprising carbon atoms as ring atoms, which are saturated, substituted or unsubstituted. In another embodiment the cycloalkyl is a 5-6 membered ring. In another embodiment, the cycloalkyl group may be unsubstituted or substituted by a halogen, an alkyl group, haloalkyl group, an hydroxide, an alkoxide, an amide, a nitro group, a cyano groups, or a carboxylate. Each possibility represents a separate embodiment of the invention.

The term “haloalkyl” refers to an alkyl as defined above which is substituted with one or more halides, in one embodiment by F, in another embodiment by Cl, in another embodiment by Br, in another embodiment by I. Non limiting examples of haloalkyls include: CF₃, CF₂CF₃, CH₂I, CH₂Br, CH₂CH₂Br, CHBrCH₃, CH₂CH₂CH₂Br, CH₂CHBrCH₃ or CHBrCH₂CH₃. Each possibility represents a separate embodiment of the invention.

The term “aryl” refers to an aromatic group having at least one carbocyclic aromatic ring, which may be unsubstituted or substituted by one or more groups selected from halogen, cyano, aryl, heteroaryl, haloalkyl, hydroxy, alkoxy carbonyl, amido, alkylamido, dialkylamido, nitro, amino, alkylamino, dialkylamino, carboxy or thio or thioalkyl. Non limiting examples of aryl rings are phenyl, naphthyl, perylene and the like. In one embodiment, the aryl group is a 5-12 membered ring. In another embodiment, the aryl group is a 5-8 membered ring. In one embodiment, the aryl group is a five membered ring. In one embodiment, the aryl group is a six membered ring. In another embodiment, the aryl group comprises of 1-4 fused rings. Each possibility represents a separate embodiment of the invention.

The term “heteroaryl” refers to an aromatic group having at least one heterocyclic aromatic ring. In one embodiment, the heteroaryl comprises at least one heteroatom such as sulfur, oxygen, nitrogen, silicon, phosphorous or any combination thereof, as part of the ring. In another embodiment, the heteroaryl may be unsubstituted or substituted by one or more groups selected from halogen, aryl, heteroaryl, cyano, haloalkyl, hydroxy, alkoxy carbonyl, amido, alkylamido, dialkylamido, nitro, amino, alkylamino, dialkylamino, carboxy or thio or thioalkyl. Nonlimiting examples of heteroaryl rings are pyranyl, pyrrolyl, pyrazinyl, pyrimidinyl, pyrazolyl, pyridinyl, furanyl, thiophenyl, thiazolyl, indolyl, imidazolyl, isoxazolyl, and the like. In one embodiment, the heteroaryl group is a 5-12 membered ring. In one embodiment, the heteroaryl group is a five membered ring. In one embodiment, the heteroaryl group is a six membered ring. In another embodiment, the heteroaryl group is a 5-8 membered ring. In another embodiment, the heteroaryl group comprises of 1-4 fused rings. In one embodiment, the heteroaryl group is 1,2,3-triazole. In one embodiment the heteroaryl is a pyridyl. In one embodiment the heteroaryl is a bipyridyl. In one embodiment the heteroaryl is a terpyridyl. Each possibility represents a separate embodiment of the invention.

In some embodiments, the term “halide” used herein refers to any substituent of the halogen group (group 17). In another embodiment, halide is fluoride, chloride, bromide or iodide. In another embodiment, halide is fluoride. In another embodiment, halide is chloride. In another embodiment, halide is bromide. In another embodiment, halide is iodide. Each possibility represents a separate embodiment of the invention.

In some embodiments, M is a monovalent cation. In another embodiment, M includes alkali metal cations, NH₄+, quaternary ammonium cation, and quaternary phoshphonium cation. In another embodiment, M is Li+. In another embodiment, M is Na+. In another embodiment, M is K+. In another embodiment, M is Rb+. In another embodiment, M is Cs+. In another embodiment, non-limiting examples of the quarternary ammonium cation, include tetrametylammonium, tetraethylammonium, tetrabutylammonium, tetraoctylammonium, trimethyloctylammonium and cetyltrimethylammonium. In another embodiment, non-limiting examples of the quarternary phosphonium cation, include tetraphenylphosphonium, dimethyldiphenylphosphonium, tetrabutylphosphonium, methyltriphenoxyphosphonium and tetramethylphosphonium. Each possibility represents a separate embodiment of the invention.

The following examples are presented in order to more fully illustrate the preferred embodiments of this invention. They should in no way, however, be construed as limiting the broad scope of this invention.

### EXAMPLES

### General

### Materials

MWCNT were purchased from Cheaptubes (10-20 nm diameter, 10-30 μm length and >95% purity). SWCNTs (Tuball™) were purchased from OCSiAl (1.2-2 nm diameter, 5 μm length and >80% purity). Ethyl-propyl perylene diimide (EP-PDI) was synthesized as reported before (Demmig, S. et al.; Chem. Ber. 121, 225-230 (1988)). Chloroform (CHCl₃) and isopropanol (IPA) were purchased from Bio-Lab (Israel). Polyvinylidene fluoride (PVDF) filter paper (0.45 μm pore size) was purchased from Merck Millipore. 1-3 Dioxolane (DOL; 99.5%, stab.), 1-2 Dimethoxyethane (DME; 99+%, stab. with BHT), Lithium bis(trifluoromethane sulfonyl)imide (LITFSI) and lithium nitrate (LiNO₃) were purchased from Alfa Aesar. Whatman® glass microfiber separator (binder free, 1.2 μm pore size, 260 μm thickness, Grade GF/C) were purchased from Sigma-Aldrich.

### Characterization Techniques

Coin cells were disassembled in the Ar-filled glovebox, cathodes were washed several times with fresh electrolyte, containing DME:DOL 1:1 volume ratio, to remove soluble species adsorbed to the surface and moved directly to Ar-filled chamber of the X-ray Photoelectron Spectroscopy (XPS) instrument or vacuum chamber of the Scanning electron microscope (SEM) instrument in order to avoid moisture/air exposure.

Scanning electron microscope (SEM) imaging was performed using a Zeiss Sigma 500 SEM, operating at 3-6 kV. Energy-dispersive X-ray spectroscopy (EDS) analysis preformed using Bruker Quantax XFlash-6 EDS detector over the Zeiss Sigma 500. Samples were glued to a stub using carbon tape.

Brunauer-Emmett-Teller (BET) adsorption studies were performed on a Quantachrome Nova 4200e instrument and the data analysis was made using Quantachrome NovaWin software. Prior to BET measurements, all samples were heated at 300° C. for 4 h under vacuum to remove surface-adsorbed species such as H₂O and other contaminations. The surface area was calculated using BET model, pore size and pore volume were calculated by the BJH approach.

Thermogravimetric Analysis (TGA) Experiments were conducted using thermal analyzer SDT Q 600 (TA instruments), under N₂ flow (100 ml\min) with a heating rate of 10° C./min. Samples were measured in alumina crucibles.

X-ray Photoelectron Spectroscopy (XPS) measurements were carried out with Kratos AXIS ULTRA system using a monochromatic Al Kα X-ray source (hν=1486.6 eV) at 75 W and detection pass energies ranging between 20 and 80 eV. Curve fitting analysis was based on Shirley or linear background subtraction and application of Gaussian-Lorenzian line shapes. Samples were loaded to the XPS instrument via glovebox and purged for several hours with N₂ to prevent air exposure.

Tensile strain test was performed on Instron Model 5965 Materials Testing System, equipped with a 10N load cell. The deformation rate was 0.2 mm/min.

All samples were cut into strips of 4-6 mm width, 25 mm length, and ~50 μm in thickness. The samples length/width and thickness were measured using digital caliper and digital micrometer, respectively.

Electrical conductivity tests were measured with Jandel cylindrical four-point collinear probe equipped with a Keithley 2401 Source Meter. For each sample, at least 10 points were measured.

### Electrochemical Measurements

The LSB coin cells cycled using BioLogic BCS-810 battery cycler with potential window of 1.6-2.8 V (vs Li/Li+) with current densities varied from 0.1 to 1C (1C equals to 1672 mA/g_{sulfur}) at room temperature. The cells were held at rest for 12 h before the cycling to insure better wettability of the separator and penetration of the electrolyte into the cathode. Electrochemical impedance spectroscopy (EIS) tests were performed within a frequency range of 1 MHz to 0.5 mHz with a voltage amplitude of 10 mV at 25° C.

### Example 1

### Preparation of the CNT/S Composite Cathode

SWCNTs powder was grinded for 10 min in pulses of 1 min. 12 mg of MWCNT, 3 mg of EP-PDI and 12 ml of CHCl₃ were mixed in a 20 ml vial, and 12 mg of ground SWCNT and 12 ml of IPA were mixed in a 20 ml vial. Both suspensions were bath-sonicated for 30 min at 15-25° C. (MRC Ultrasonic Cleaner D80H bath sonicator). The resulting suspensions were vacuum-filtered through a PVDF membrane: the SWCNT suspension was filtered first and then the MWCNT suspension, resulting in a film having the MWCNT layer on top of the SWCNT layer. The obtained composite buckypaper (BP) was washed with CHCl₃ to remove EP-PDI excess. The wet BP on a PVDF filter was treated using an office lamination machine at room temperature, dried at 110° C. for 2 h and peeled off the PVDF filter paper. Typical BP dimensions are 41 mm in diameter and ~35-65 μm in thickness. The resulting free-standing BP was weighted and sulfur powder was dispersed uniformly on top of the BP, and heated over hot plate at 155° C. for 2 h, upon which the melted sulfur was adsorbed within the BP. The CNT/S BP was cooled to room temperature. Discs (13 mm in diameter) were punched from BP using a steel circle cutter, and dried under vacuum (P~100 mTorr) overnight. The obtained discs were used directly as cathodes for the Li—S cell assembly. In cases where composites without sulfur were required, the whole procedure was done as detailed above with the omission of the sulfur addition/treatment step(s).

The Preparation route of the sulfur-CNT composite cathode (“sulfur-containing composite”) film is illustrated in FIG. 3. Tuball™ SWCNTs which are cost-effective and have advantageous structural properties (high length) were used. Bath sonication was applied for de-bundling of the CNT network, forming smaller bundles and resulting in higher surface area. Solution fabrication provided a free-standing composite BP. The cathode or cathode material was prepared by spreading the sulfur powder over the MWCNT layer, and heating to 155° C. (FIG. 3), where melted sulfur has its lowest viscosity.

### Example 2

### Preparation of Battery (Cell Assembly)

DME and DOL were passed through an alumina column. The solvents were degassed by Argon bubbling for 10 min, and molecular sieves (3 Å) were added to remove residual water. LiTFSI and LiNO₃ were heated to 140° C. in an oil bath and vacuumed (P~100 mTorr) for overnight. The dried materials were introduced into an Ar-filled glove box, where battery electrolyte was made by mixing DME:DOL 1:1 volume ratio, 1M LiTFSI and 1 wt % LiNO₃. Electrolyte volume was fixed to 70 μl for all cells. Batteries were made using CR2032-coin cell case and fabricated in an Ar-filled glove box (water and oxygen contents less than 0.5 ppm). Each battery contained cathode, 13 mm in diameter (made as described above in Example 1), 14 mm Whatman® glass-microfiber separator (binder free, Grade GF/C, dried for 12 h at 70° C.) and 380 μm-thick Li metal foil as an anode.

The coin cell consists of Li metal anode, borosilicate microfiber separator, ether-based electrolyte and sulfur-containing composite as a cathode, where the cathode MWCNT side faces the electrolyte (FIG. 4).

### Example 3

### Cathode, Sulfur-Containing and Non-Sulfur Composites Characterization

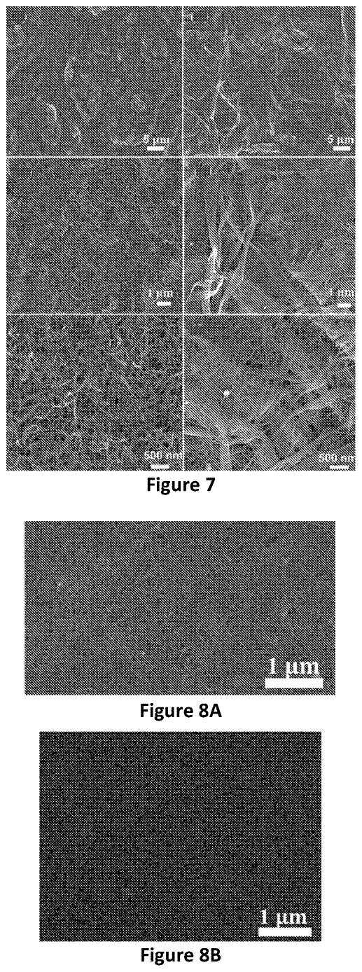

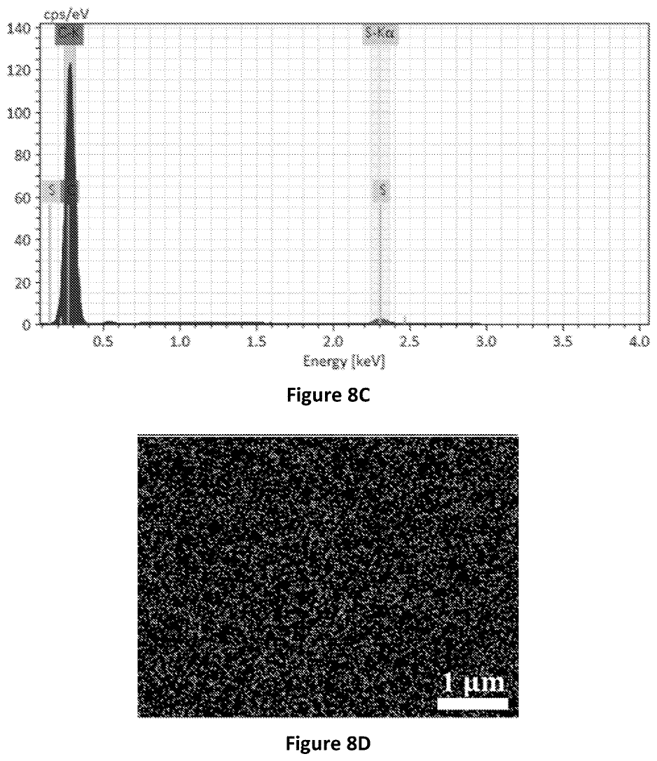

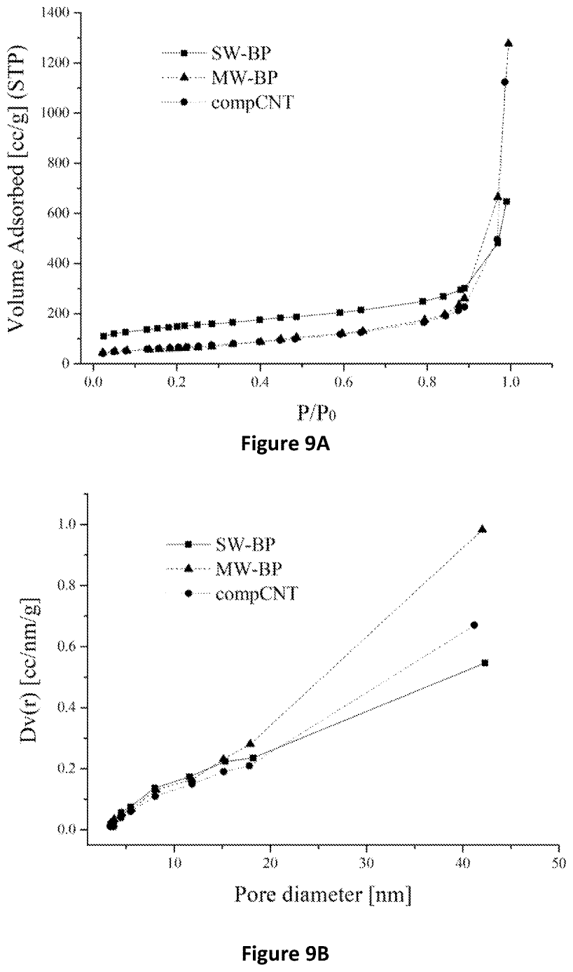

The cathode, comprising the sulfur containing composite, was characterized to obtain insights into structure, composition, mechanical properties, and conductivity. Thermogravimetric Analysis (TGA) data is shown in FIG. 5, indicating that sulfur content by weight within the composite is ~65%. SEM imaging and EDS elemental analysis were performed to probe morphology and elemental composition of sulfur-containing composite. Cross-section view in FIG. 6D shows that the sulfur-containing composite consists of 3 main layers: upper MWCNT layer, middle interlayer of MWCNT wrapped around bundled SWCNT, and the bottom SWCNT layer. Higher magnification images (FIG. 7) show good MWCNT exfoliation. The distribution of sulfur across the composite was characterized by EDS elemental mapping (FIGS. 6A-6C). Sulfur is adsorbed mainly within the lower SWCNT layer and homogeneously distributed; sulfur-containing composite surface morphology is shown in FIGS. 8A-8D. The composite has relative smooth surface and no large aggregates or particles are observed. Sulfur is homogeneously distributed over the surface, but S amounts are significantly lower as it is mostly accumulated in the bottom SWCNT layer (FIG. 8C) due to its higher specific surface area (SSA) (see below). Different cross-section images indicate that sulfur-containing composite thickness is 50±10 [μm].

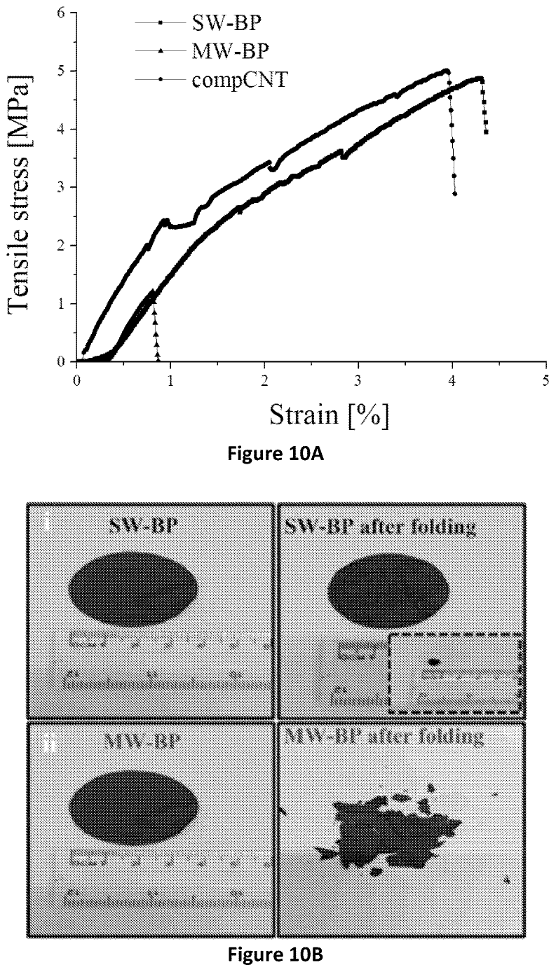

N₂ adsorption/desorption studies were performed in order to investigate the porosity of the materials. Surface area (SA) was calculated using Brunauer-Emmett-Teller (BET) model, while pore size and pore volume were calculated using Barrett-Joyner-Halenda (BJH) approach. Results are summarized in Table 1, and N₂ adsorption isotherms, pore diameters distributions and original isotherms of the samples are presented in FIGS. 9A-9B, indicating that MW-BP (multiwalled carbon nanotube buckypaper) shows larger pore diameters (>20 nm) compared with SW-BP (single walled carbon nanotube buckypaper) while non-sulfur-composite (“compCNT”) pore distributions seems to be midpoints between the two. SA calculations using BET model showed that SW-BP has SA of 517.2 m²/g, MW-BP SA is 216.4 m²/g, and for non-sulfur-composite SA is 270 m²/g.

TABLE 1
Comparison of SW-BP, MW-BP and compCNT (non-sulfur composite) properties: (left) Mechanical
properties; (middle) Electrical properties; (right) N₂ adsorption studies.

| | Mechanical | | | Electrical | | N₂ | |
|---|---|---|---|---|---|---|---|
| | Properties | | | Conductivity | | Adsorption | |
| | Youngs | | | | Volume | Surface | Pore |
| | modulus | UTS | Strain | 2-Probe | conductivity | area | volume |
| | [Mpa] | [Mpa] | [%] | [Ω] | [S/m] | [m²/g] | [cm³/g] |
| SW-BP | 182 ± 46 | 3.9 ± 1.2 | 4.1 ± 0.7 | 7.5 ± 0.8 | 3.5 × 10⁵ ± 2.7 × 10⁴ | 517.2 ± 35.8 | 0.73 ± 0.05 |
| MW-BP | 25 ± 8 | 0.4 ± 0.3 | 0.5 ± 0.2 | 70.9 ± 3.0 | 9.6 × 10³ ± 3.7 × 10² | 216.4 ± 4.5 | 1.14 ± 0.03 |
| compCNT | 105 ± 30 | 2.1 ± 0.6 | 3.9 ± 1.0 | 6.1 ± 0.7 | 2.8 × 10⁵ ± 4.8 × 10⁴ | 270.2 ± 4.0 | 0.83 ± 0.01 |

Conductivity measurements of SW-BP, MW-BP and non-sulfur-composite were performed using 2-probe and 4-probe measurements (Table 1). MW-BP volume conductivity was one to two order of magnitudes lower compared to those of SW-BP and non-sulfur-composite.

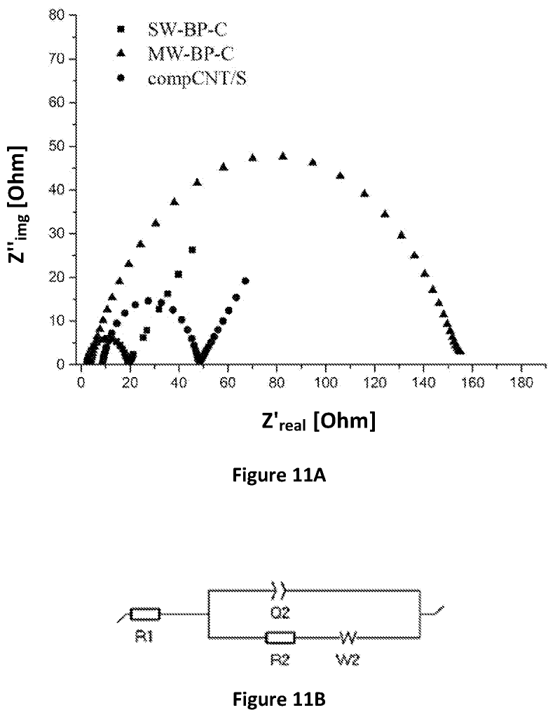

The mechanical properties of SW-BP, MW-BP and non-sulfur-composite were investigated by stress-strain test (FIG. 10a, Table 1). MW-BP has significantly lower tensile strength and flexibility and as a result crushes under mechanical impact (FIG. 10b). This feature makes MW-BP difficult to be manufactured into small discs for further use as LSB (lithium sulfur batteries) cathodes. Moreover, flexibility and mechanical strength play key rule for LSB due to the severe volume expansion of the sulfur cathode upon lithiation which require the cathode adaptation to mechanical stress during cell operation. Importantly, non-sulfur-composite possesses flexibility and mechanical strength similar to SW-BP. In contrast to the common use of non-conductive binder (such as PVDF) in LSB cathodes (Yuan, H.; Huang, J.-Q.; Peng, H.-J.; Titirici, M.-M.; Xiang, R.; Chen, R.; Liu, Q.; Zhang, Q. A Review of Functional Binders in Lithium-Sulfur Batteries. Advanced Energy Materials 2018, 8 (31), 1802107. https://doi.org/10.1002/aenm.201802107), the cathode of this invention utilizes functional SWCNT layer.

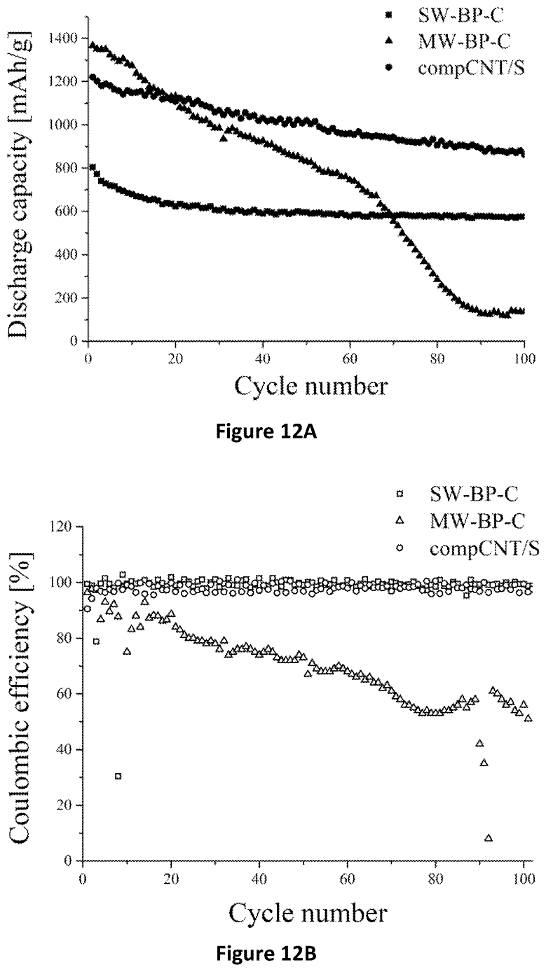

To compare the internal resistance of SW-BP-C, MW-BP-C and sulfur-containing composite cells, electrochemical impedance spectroscopy (EIS) was carried out. Fresh cells before cycling were measured (FIG. 11A), equivalent circuit and its components are presented in FIG. 11B. The semi-circle from the high to medium frequency region is the non-linear charge transfer resistance (R2) at the electrode-electrolyte interface, while the inclined line in lower frequency region is the Warburg impedance (W2), corresponding to ions diffusion (Waluś, S.; Barchasz, C.; Bouchet, R.; Alloin, F. Electrochemical Impedance Spectroscopy Study of Lithium-Sulfur Batteries: Useful Technique to Reveal the Li/S Electrochemical Mechanism. Electrochimica Acta 2020, 359, 136944. https://doi.org/10.1016/j.electacta.2020.136944; Deng, Z.; Zhang, Z.; Lai, Y.; Liu, J.; Li, J.; Liu, Y. Electrochemical Impedance Spectroscopy Study of a Lithium/Sulfur Battery: Modeling and Analysis of Capacity Fading. Journal of The Electrochemical Society 2013, 160 (4), A553-A558. https://doi.org/10.1149/2.026304jes; Xiao, J.; Wang, H.; Li, X.; Wang, Z.; Ma, J.; Zhao, H. N-Doped Carbon Nanotubes as Cathode Material in Li—S Batteries. Journal of Materials Science: Materials in Electronics 2015, 26 (10), 7895-7900. https://doi.org/10.1007/s10854-015-3441-1). All cells showed semi-circle curves, whose diameter corresponds to charge transfer resistance. SW-BP-C cells presented the smallest diameter, exhibiting resistance of 17 Ohm, MW-BP-C cells showed significantly higher resistance of 151 Ohm, while sulfur-containing composite cell showed resistance of 39 Ohm.

### Example 4

### Battery Performance of the Sulfur Containing Composites

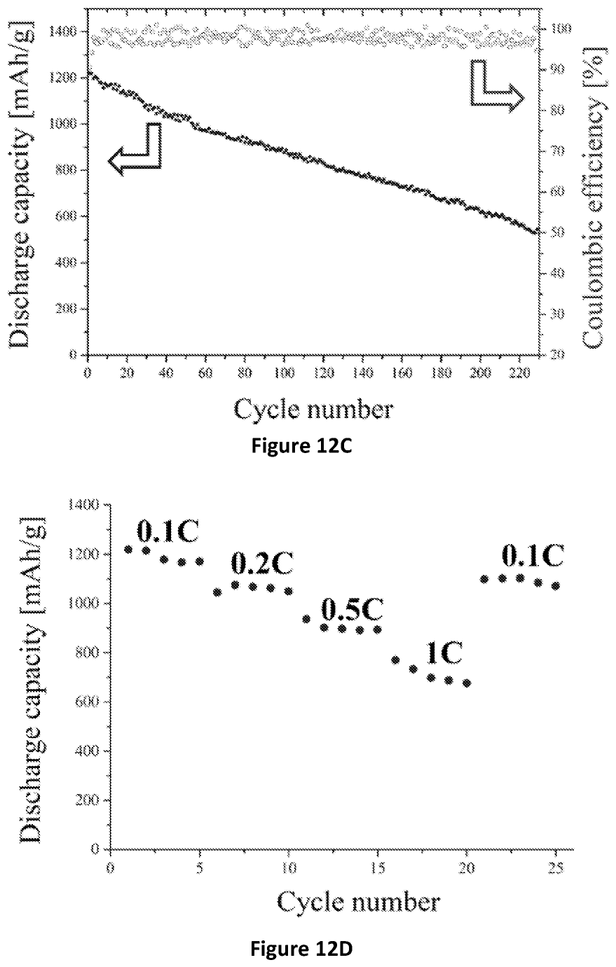

FIG. 4 illustrates coin cell configuration, where the cathode MWCNT side faces the electrolyte (70 μl DME:DOL at 1:1 volume ratio, and 1M LiTFSI with 1 wt % LiNO₃ additive), Li metal serves as the anode and borosilicate glass as the separator. To obtain insights into sulfur-containing composite performance, we tested it in comparison to cells having single-component SW-BP cathode (SW-BP-C) or MW-BP cathode (MW-BP-C). All cells were cycled at various rates under a voltage window of 1.6-2.8 V versus Li+/Li, capacity values were calculated based on sulfur loading mass for each cathode. The sulfur-containing composite cells reached impressive peak discharge capacity of 1221 mAh/g at 0.1C (FIG. 12a). Even after 100 cycles, the composite cathode delivered a capacity of 876 mAh/g at 0.1C, corresponding to a retention of 72%. Coulombic efficiency (CE) was close to 100% during all cycles. By contrast, although MW-BP-C cell reached peak discharge capacity of 1336 mAh/g at 0.1C, it decays to discharge capacity of 671 mAh/g just after 66 cycles, corresponding to a capacity retention of 50%. CE decayed over time, which can point to parasitic side reactions. On the other hand, although SW-BP-C cell exhibit capacity retention of 73% after 100 cycles and maintain CE close to 100% during cycling, the cell demonstrated lower peak discharge capacity of 802 mAh/g at 0.1C rate. For more reliable data of cathodes performance, a statistical comparison was made, based on 25 SW-BP-C, 25 MW-BP-C, and 50 sulfur-containing composite cells. All cells were prepared as described in Example 2 and cycled at 0.1C rate under the same voltage window. Table 2 shows that sulfur-containing composite cells exhibit superior performance while maintaining average capacities close to MW-BP-C cells together with 100th cycle retention close to SW-BP-C cells.

TABLE 2
Comparison of SW-BP-C, MW-BP-C, and compCNT/S Cells Cycled at
a 0.1 C Rate with Voltage Window of 1.6-2.8 V versus Li⁺/Li*

| | Average peak | Average 100^{th} | Average 100^{th} |
|---|---|---|---|
| | capacity | cycle capacity | cycle retention |
| | [mAh/g] | [mAh/g] | [%] |
| SW-BP-C | 645 ± 136 | 480 ± 156 | 70 ± 16 |
| MW-BP-C | 989 ± 255 | 444 ± 148 | 51 ± 15 |
| compCNT/S | 838 ± 120 | 585 ± 71 | 68 ± 7 |

*Average calculations based on 25 cells for the compCNT/S case and 12 cells for the SW-BP-C and MW-BP-C cases.

### Example 5

### Sulfur-Containing Composite Cathode Post-Function Characterization

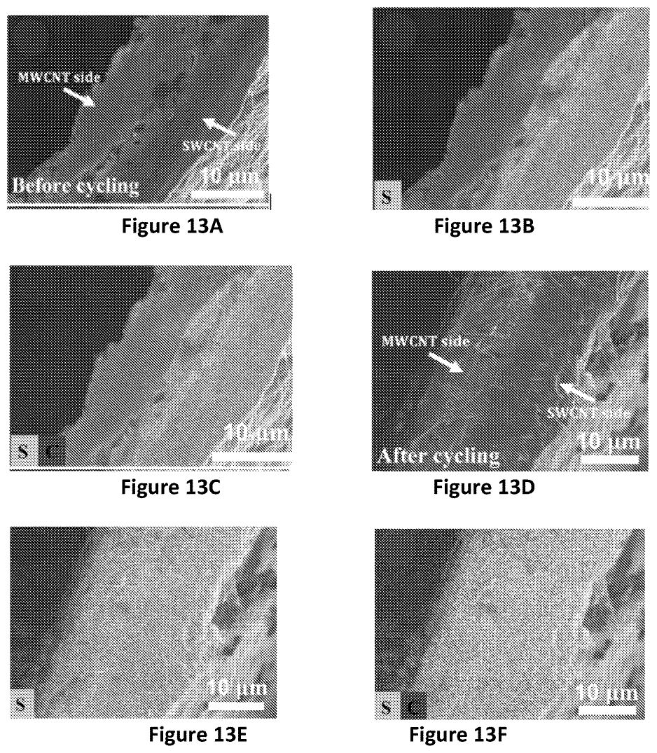

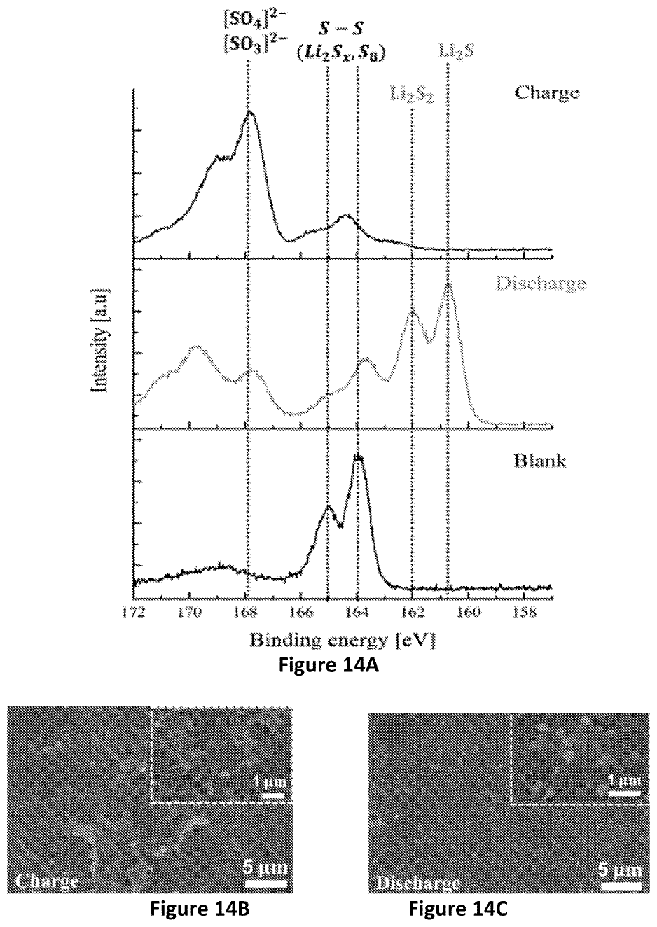

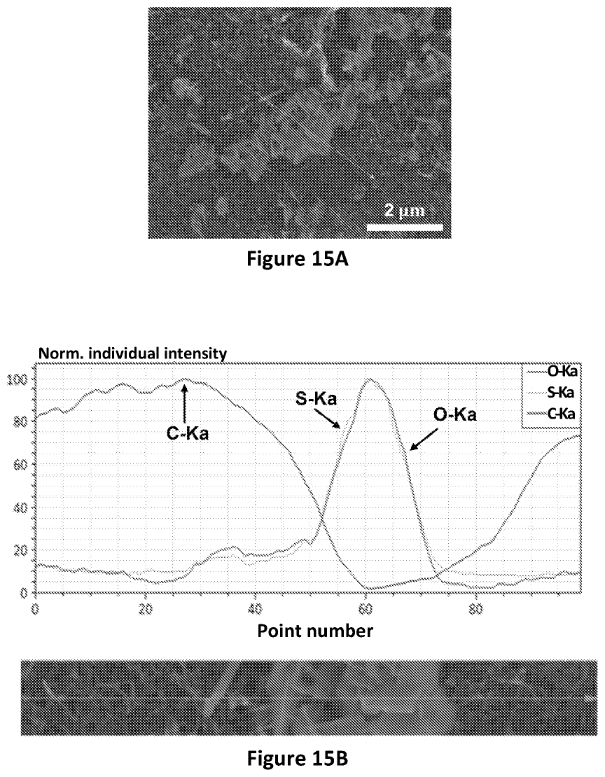

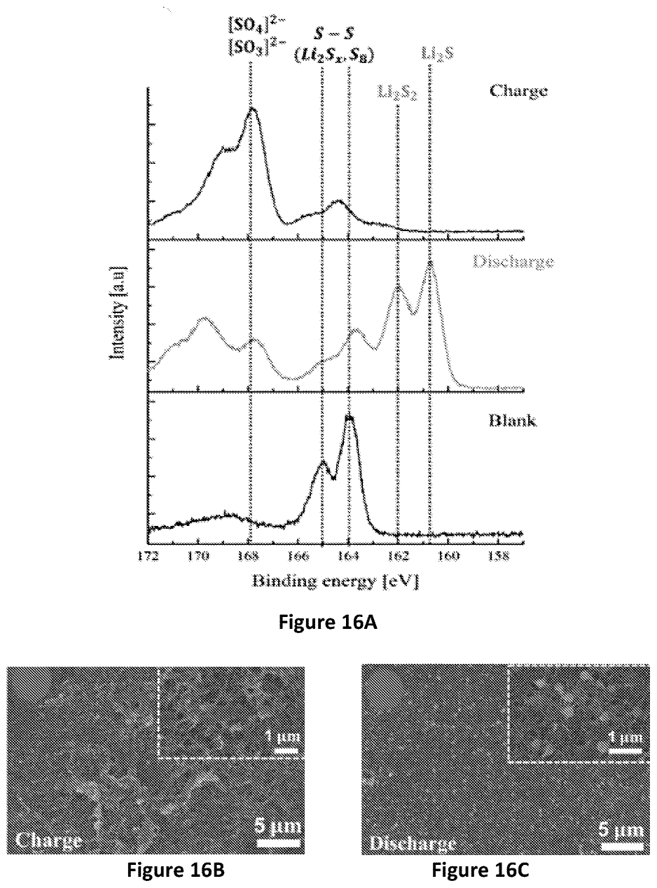

For better understanding of the species forming during cycling and the morphology of cells. cathodes, selected cells were disassembled in the Ar-filled glovebox and investigated by XPS and SEM-EDS analysis. FIGS. 13A-13F shows cross-sectional EDS of sulfur-containing composite before and after cycling. Evidently, although sulfur is mainly adsorbed within the SWCNT layer before cycling (FIG. 13b), in post-operation cathode, sulphur-containing species are adsorbed also within the MWCNT layer (FIG. 13e), resulting in relatively uniform distribution of S over the sulfur-containing composite layers. FIG. 14A-14C presents XPS and corresponding SEM images of the cathode during charge and discharge. Charge state refers to a sulfur-containing composite cell stopped after 50 cycles at 2.4V while charging, where the solid products Li₂S and Li₂S₂ are known to oxidize to longer polysulfides chains (Li₂Sₓ) and later to elemental sulfur S₈. The dominant peak emission is at 167.8 eV, it originates from Sulfate [S0₄]²⁻, Sulfite [S0₃]²⁻ or Thiosulfate [S—S0₃]²⁻ while higher energy peaks assign to SOₓF_{y} (x=1-4, y=1-6) [35-38]. Another clear proof for oxidized sulfur species observed in FIGS. 15A-15B was obtained from the analysis of sulfur-containing composite cell, stopped after 50 cycles and opened for SEM-EDS measurement. These oxidized sulfur species probably originate from oxidation reaction caused by the LiNO₃ additive as suggested in the literature (Aurbach, D.; Pollak, E.; Elazari, R.; Salitra, G.; Kelley, C. S.; Affinito, J. On the Surface Chemical Aspects of Very High Energy Density, Rechargeable Li-Sulfur Batteries. Journal of The Electrochemical Society 2009, 156 (8), A694. https://doi.org/10.1149/1.3148721). The discharge state refers to sulfur-containing composite cell stopped after 50 cycles at 1.8 V while discharging, corresponding to the area where polysulfide chains (Li₂Sₓ) are reduced to insoluble LiₛS and Li₂S₂. The XPS shows two dominant peaks at 160.6 eV and 162.0 eV, corresponding to LiₛS and Li₂S₂ respectively. The peaks that correspond to the oxidized sulfur, 167.8 eV and 170.0 eV (FIG. 16A), are not negligible, indicating that some sulfur probably underwent irreversible oxidation (leading to capacity fading). XPS of the cell before cycling is shown in FIG. 16A (blank). The dominant peak located at 164.0 eV corresponds to elemental sulfur (S₈), as expected.

### DISCUSSION

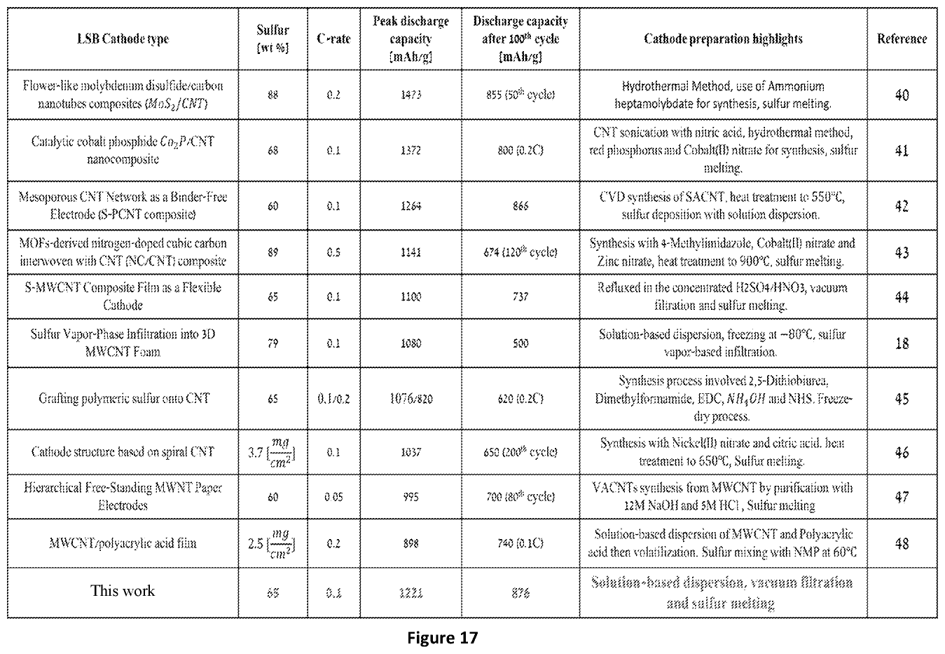

The sulfur-containing composite cathode demonstrates performance superior to that of the cathodes composed from SWCNT or MWCNT only. SWCNT component has a high surface area, enabling high sulfur loading and excellent connection between the non-conductive sulfur and the CNT network leading to enhanced electronic transport. It also features mechanical strength and flexibility, which are crucial in LSB operation due to the severe volume changes sulfur undergoes upon cycling. On the other hand, MWCNT component is characterized by advantageous mesoporous structure that can provide efficient pathways for lithium-ion diffusion and electrolyte wettability within the pores and facilitate the immobilization of LiPS. This integration of the above components results in advantageous cathode characteristics. The wide statistical comparison (Table 2) is an important factor for reliable statements of the cathode performance based on a high numbers of cells. This statistical analysis shows that the sulfur-containing composite cathode has average capacities close to MW-BP-C cells together with the cycling stability and columbic efficiencies associated with SW-BP-C cells. Post-cycling characterization indicates that the sulfur-containing composite stays mechanically intact and no major fracture appears over the surface, revealing good mechanical durability. Sulfur migration to MWCNT layer during cycling is observed, emphasizing the importance of the overall robustness. FIG. 17 presents a comparison to the published LSB cathodes based on CNT. Some works (Walle, M. D.; Zeng, K.; Zhang, M.; Li, Y.; Liu, Y.-N. Flower-like Molybdenum Disulfide/Carbon Nanotubes Composites for High Sulfur Utilization and High-Performance Lithium-Sulfur Battery Cathodes. Applied Surface Science 2019, 473, 540-547. https://doi.org/10.1016/j.apsusc.2018.12.169; Shi, Z.; Feng, W.; Wang, X.; Li, M.; Song, C.; Chen, L. Catalytic Cobalt Phosphide Co₂P/Carbon Nanotube Nanocomposite as Host Material for High Performance Lithium-Sulfur Battery Cathode. Journal of Alloys and Compounds 2021, 851, 156289. https://doi.org/10.1016/j.jallcom.2020.156289; and Fang, R.; Chen, K.; Sun, Z.; Wang, D.-W.; Li, F. Sulfur-Carbon Composite Cathodes. Modern Aspects of Electrochemistry 2022, 19-82. https://doi.org/10.1007/978-3-030-90899-7_2) indicate better peak capacities and/or cycling stability, yet the preparation processes of the cathodes often make use of expensive materials and/or complex synthesis protocols involving the use of strong acids or bases, high temperatures, etc., which present challenges to scale-up and may involve safety concerns. Our cathode preparation is solution-based, expedient, and involves nontoxic and inexpensive materials. It is also highly modular, allowing for different configurations, and exhibits reliable performance as verified by studies on multiple cells (50 devices).

### CONCLUSIONS

A composite CNT cathode for LSBs was developed, and made by simple, non-toxic and cost-effective process of vacuum filtration and sulfur melting deposition. Due to the nature of CNTs employed, there is no need of binders, conductive additives and current collectors. Sulfur-containing composite takes advantage of the surface area, conductivity and mechanical properties of SWCNT together with superior porous morphology of MWCNT, leading to well-distributed sulfur-carbon network with enhanced electron transport, high durability, and mechanical robustness. Consequently, initial capacity of 1221 mAh/g at 0.1C was achieved. The cell maintains capacity of 876 mAh/g and 616 mAh/g at 0.1C after 100 and 200 cycles, respectively. The simple and modular preparation method of the proposed composite cathode and its free-standing nature makes it promising candidate for other energy storage systems where conductive, flexible and porous electrode is needed.

While certain features of this invention have been illustrated and described herein, many modifications, substitutions, changes, and equivalents will now occur to those of ordinary skill in the art. It is, therefore, to be understood that the appended claims are intended to cover all such modifications and changes as fall within the true spirit of this invention.

1. A composite comprising a multi-layered structure comprising at least one layer of multi-walled carbon nanotube (MWCNT) and at least one layer of single-walled carbon nanotube (SWCNT), wherein the weight ratio of the MWCNT to SWCNT is 10:1 to 1:10, respectively, sulfur; and each layer optionally further consists of an aromatic compound.

2. The composite of claim 1, wherein the layers are organized as blocks, alternating or random configuration.

3. (canceled)

4. The composite of claim 1 comprises an aromatic compound.

5. (canceled)

6. (canceled)

7. The composite of claim 1, wherein, the first layer is a SWCNT.

8. The composite according to claim 1, wherein the aromatic compound is at least one of perylene diimide, naphthalene diimide, phthalocyanine, anthraquinone, acridine, naphthalene disulfonic acid, caffeic acid, phenazine, indigo, rhodamine, phenothiazine, thymolphthalein, aramid, derivative thereof, salt thereof or any combination thereof.

9. The composite of claim 8, wherein the perylene diimide derivative is ethyl propyl perylene diimide, or the anthraquinone derivative is a dihydroxy or trihydroxy anthraquinone, or wherein the acridine derivative is acridine orange, or the phenazine derivative is safranin.

10. (canceled)

11. The composite according to claim 8, wherein the anthraquinone derivative is purpurin or alizarin.

12. (canceled)

13. (canceled)

14. The composite according to claim 1, wherein the weight ratio of the MWCNT to SWCNT is 1:1, respectively.

15. The composite according to claim 1, wherein the sulfur weighs 55-75% of the composition total weight.

16. The composite of claim 15, wherein the sulfur weighs 65% of the composition total weight.

17. The composite according to claim 1, wherein the composite is a membrane, dispersion, buckypaper, bulk material, coating, film, paste, paint, gel, powder or aerogel.

18. The composite of claim 17, being a buckypaper or a free-standing buckypaper.

19. (canceled)

20. The composite according to claim 1, wherein the SWCNT is a grinded SWCNT.

21. The composite according to claim 1, wherein the MWCNT layer is found above the SWCNT layer.

22. The composite of claim 1, having a Young's modulus of 60-150 Mpa, or an electrical conductivity of 2-4×10⁵ S/m, or a surface area of 250-300 m²/g, or a pore volume of 0.6-1 cm³/g or combination thereof.

23. (canceled)

24. (canceled)

25. (canceled)

26. (canceled)

27. (canceled)

28. A method of preparing a sulfur-containing composite of claim 1 comprising:
mixing multi-walled carbon nanotube (MWCNT), a first solvent and optionally an aromatic compound;
mixing a grinded single-walled carbon nanotube (SWCNT), a second solvent and optionally an aromatic compound;
sonicating separately both mixtures;
filtering the sonicated SWCNT mixture over a membrane and then filtering the sonicated MWCNT mixture over the membrane with the filtered SWCNT, providing a film having the MWCNT layer on top of the SWCNT layer;
washing the provided film with the first solvent to remove excess optional aromatic compound;
laminating the provided film, providing a layered film and then peeling the layered film off the membrane;
adding sulfur to the top of the layered film while heating to 120-180° C.; and
cooling the sulfur treated film to room temperature to obtain the composite.

29. The method of claim 28, wherein the aromatic compound is perylene diimide, naphthalene diimide, phthalocyanine, anthraquinone, acridine, naphthalene disulfonic acid, caffeic acid, phenazine, indigo, rhodamine, phenothiazine, thymolphthalein, aramid, derivative thereof, salt thereof or any combination thereof.

30. A cathode consists essentially of the composite according to claim 1.

31. A method of preparing a cathode of claim 30, comprising
cutting the composite; and
drying the cut composite to provide the cathode.

32. A battery comprising a cathode according to claim 30, a lithium metal anode and an electrolyte.

33. The battery of claim 32, further comprising a separator.

34. The battery of claim 32, having an average peak capacity of 800-1100 mAH/g with current densities of from 0.1 to 1C and potential range of 1.6-2.8 V (vs Li/Li+).

35. The battery according to claim 32, having an average 100th cycle retention of 65-80%.

36. The battery according to claim 32, wherein the MWCNT side of the cathode faces the electrolyte, and the anode faces the other side of the electrolyte.

37. (canceled)
